(19) United States
(12) Patent Application Publication
(10) Pub. No.: US 2025/0104708 A1
(43) Pub. Date: Mar. 27, 2025

(54) SMART VEHICLE ASSISTANT

(71) Applicant: State Farm Mutual Automobile Insurance Company, Bloomington, IL (US)

(72) Inventor: Brian N. Harvey, Bloomington, IL (US)

(21) Appl. No.: 18/828,812

(22) Filed: Sep. 9, 2024

Related U.S. Application Data
(60) Provisional application No. 63/584,361, filed on Sep. 21, 2023.
(60) Provisional application No. 63/584,346, filed on Sep. 21, 2023.
(60) Provisional application No. 63/591,403, filed on Oct. 18, 2023.
(60) Provisional application No. 63/591,409, filed on Oct. 18, 2023.

(51) Int. Cl. G10L 15/22; B60W 30/08; B60W 50/14; G06Q 50/26; H04W 4/90

(52) U.S. Cl. CPC G10L 15/22; B60W 30/08; B60W 50/14; G06Q 50/26; H04W 4/90; B60W 2030/082

(57) ABSTRACT

A vehicle chatbot of a smart vehicle assistant engages in a conversation with a user associated with a vehicle, for instance to provide insurance information and range extension tips associated with vehicle operations. The vehicle chatbot may also engage in a conversation with an external entity in the event of a collision, to provide information to the external entity on behalf of vehicle occupants. The smart vehicle assistant may also cause the vehicle to autonomously drive to a location following a collision. A responder dispatched to respond to the collision may use a smart responder assistant that includes a responder chatbot. The responder chatbot may engage in a conversation with the responder to obtain information identifying the vehicle and/or damage to the vehicle, and may provide the responder with information about the vehicle and recommendations regarding how to extract occupants of the vehicle.

### PRIORITY

This U.S. patent application claims priority to U.S. Provisional Patent Application No. 63/584,361, filed on Sep. 21, 2023 and entitled “SMART VEHICLE ASSISTANT,” U.S. Provisional Patent Application No. 63/584,346, filed on Sep. 21, 2023 and entitled “SMART RESPONDER ASSISTANT,” U.S. Provisional Patent Application No. 63/591,403, filed on Oct. 18, 2023 and entitled “SMART VEHICLE ASSISTANT,” and U.S. Provisional Patent Application No. 63/591,409, filed on Oct. 18, 2023 and entitled “SMART RESPONDER ASSISTANT,” the disclosures of which are incorporated herein by reference in their entirety.

### TECHNICAL FIELD

The present disclosure relates to smart assistants that include chatbots, particularly with respect to a smart vehicle assistant that assists occupants of a vehicle, and to a smart responder assistant that assists emergency services personnel or other responders who respond to vehicle collisions.

### BACKGROUND

Vehicles, including electric vehicles and/or autonomous vehicles, may transport one or more occupants to destinations. Occupants of a vehicle may, however, be unsure whether insurance coverage is in place to cover operations of the vehicle, and/or be unsure how best to maximize battery life or range of the vehicle during a trip. In situations in which a vehicle is involved in a collision, occupants may be unable to contact emergency services and/or may be unable to drive the vehicle to another location to obtain medical services or other assistance.

Additionally, when a vehicle is involved in a collision, one or more occupants may be trapped in the vehicle. A responder associated with emergency services may be dispatched to respond to the collision and extract the occupants. However, if the structure of the vehicle has been damaged, and/or if the vehicle is an electric vehicle and high-voltage cables or other electrical elements are present throughout the structure of the vehicle, the responder may be unsure which portions of the vehicle may be safe, or unsafe, to cut in order to extract the occupants. The responder may also be unsure which portions of the vehicle should be cut in order to extract the occupants most quickly.

The exemplary computer systems and computer-implemented methods described herein may be directed toward mitigating or overcoming one or more of the deficiencies described above. Conventional techniques may have additional drawbacks, inefficiencies, ineffectiveness, and/or encumbrances as well.

### BRIEF SUMMARY

Described herein are systems and methods by which one or more smart assistants, executed via vehicle dashboard systems, via user devices, and/or via other computing systems, may provide, inter alia, information to users in association with a vehicle. The smart assistants may include a smart vehicle assistant that assists drivers or other occupants of a vehicle, for instance by providing insurance information, by providing tips to extend the battery life and/or travel range of the vehicle, and/or by assisting with a response to a collision involving the vehicle. The smart assistants may also, or alternately, include a smart responder assistant that assists a responder who is dispatched to respond to a collision involving the vehicle, for instance by providing information about electrical systems of the vehicle and recommendations regarding which portions of the vehicle are safest and/or quickest to cut to extract trapped occupants of the vehicle. The smart assistants may each include a chatbot (or voice bot) that a user may interact with to ask questions and/or receive information, for instance via a natural language conversion based upon text and/or audio input and output.

According to a first aspect, a computer-implemented method may include providing a smart vehicle assistant. The computer-implemented method may be implemented via one or more local or remote processors, servers, transceivers, sensors, memory units, mobile devices, wearables, smart watches, smart contact lenses, smart glasses, Augmented Reality (AR) glasses, Virtual Reality (VR) headsets, Mixed Reality (MR) or extended Reality (XR) glasses or headsets, voice bots or chatbots, ChatGPT or ChatGPT-based bots, and/or other electronic or electrical components, which may be in wired or wireless communication with one another. For example, in one instance, the computer-implemented method may include (1) providing, by a vehicle computing system of a vehicle that includes one or more processors, a smart vehicle assistant including a chatbot. The chatbot may be trained, based upon a training dataset, to engage in a conversation with a user in association with the vehicle. The computer-implemented method may also include (2) receiving, by the vehicle computing system, and/or via the chatbot during the conversation, user input. The user input may include, for example, natural language input. The computer-implemented method may additionally include (3) generating, by the vehicle computing system, and/or via the chatbot, natural language output based at least in part on the user input. The method may also include (4) presenting, by the vehicle computing system, and/or via the chatbot, the natural language output during the conversation. The method may include additional, less, or alternate functionality and actions, including those discussed elsewhere herein.

According to a second aspect, a computing system may provide a smart vehicle assistant. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer system may include a vehicle computing system of a vehicle, including one or more processors, and memory storing computer-executable instructions. The computer-executable instructions, when executed by the one or more processors, cause the one or more processors to (1) provide a smart vehicle assistant. The smart vehicle assistant may include a chatbot trained, based upon a training dataset, to engage in a conversation with a user in association with the vehicle, wherein the user is: an occupant of the vehicle, or associated with an external entity separate from the vehicle. The computer-executable instructions may also cause the one or more processors to (2) receive, via the chatbot during the conversation, user input including natural language input. The computer-executable instructions may additionally cause the one or more processors to (3) generate, via the chatbot, natural language output based at least in part on the user input. The computer-executable instructions may also cause the one or more processors to (4) present, via the chatbot, the natural language output during the conversation. The computer system may include additional, less, or alternate functionality, including that discussed elsewhere herein.

According to a third aspect, one or more non-transitory computer-readable media store computer-executable instructions that may be executed by one or more processors of a computing system. The computing system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computing system may be a computing system of a vehicle, and the computer-executable instructions, when executed by one or more processors of the computing system of the vehicle, may cause the one or more processors to: (1) provide a smart vehicle assistant including a chatbot. The chatbot may be trained, based upon a training dataset, to engage in a conversation with a user in association with the vehicle, wherein the user is: an occupant of the vehicle, or associated with an external entity separate from the vehicle. The computer-executable instructions may also cause the one or more processors to (2) receive, via the chatbot during the conversation, user input including natural language input. The computer-executable instructions may additionally cause the one or more processors to (3) generate, via the chatbot, natural language output based at least in part on the user input. The computer-executable instructions may also cause the one or more processors to (4) present, via the chatbot, the natural language output during the conversation. The computer-executable instructions may cause additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an exemplary computing environment associated with at least one of a smart vehicle assistant or a smart responder assistant.

FIG. 2 shows a flowchart illustrating an exemplary computer-implemented method for training and using a vehicle chatbot associated with the smart vehicle assistant.

FIG. 3 shows a flowchart illustrating an exemplary computer-implemented method for using the smart vehicle assistant to respond to a collision involving a vehicle.

FIG. 4 shows a flowchart illustrating an exemplary computer-implemented method for training and using a responder chatbot associated with the smart responder assistant.

FIG. 5 shows an exemplary system architecture for a computing system that may execute one or more elements associated with the smart vehicle assistant, the smart responder assistant, a model training system, and/or other elements described herein.

The detailed description is set forth with reference to the accompanying figures. In the figures, the left-most digit(s) of a reference number identifies the figure in which the reference number first appears. The use of the same reference numbers in different figures indicates similar or identical items or features.

### DETAILED DESCRIPTION

Computer systems and computer-implemented methods are described herein by which one or more smart assistants, executed via vehicle dashboard systems, via user devices, and/or via other computing systems, may provide, inter alia, information to users in association with a vehicle. The smart assistants may include chatbots or voice bot functionality.

In certain embodiments, a smart assistant may be a ChatGPT-based bot (or other generative AI bot) that may be provided within autonomous or semi-autonomous vehicles, including autonomous or semi-autonomous electric vehicles (EVs). Additionally or alternatively, a smart assistant may be a ChatGPT-based bot (or other generative AI bot) that that may be provided within autonomous or semi-autonomous vehicles, including autonomous or semi-autonomous EVs and specifically dedicated or designed with first responder functionality (e.g., functionality intended for, or that is helpful to, first responders).

### ChatGPT-Based BOT in Autonomous EVS

Autonomous Electric Vehicles (EVs) may pose some unique circumstances with regard to coverage, claims, and operation. Sometimes an insured doesn't think to start such conversations. Having a ChatGPT-based chatbot or voice bot capable of initiating such conversations may provide several benefits to the insured and insurance providers.

A trained ChatGPT-based chatbot may be incorporated into an EV for the purpose of helping insureds better understand these topics. Some of these capabilities may also be leveraged outside of an EV.

Examples of what information and education the present Chatbot may provide include answering questions regarding coverage of the EV when the insured isn't physically operating/controlling the direction and speed of the EV (as it is autonomous). These types of answers may be specific to insurance products and coverage of the insured if a policy is in force.

The Chatbot may also be able to connect to an insurance provider's remote server, and provide a quote for a policy holder via wireless communication to their mobile device, as well as bind coverage. If coverage exists, changing limits may be possible.

If there is a collision, the computer system may initiate a conversation with the occupants to collect information that may be used for claim purposes. For example, if the collision is severe enough, the system may initiate a conversation with the occupants and determine if they require medical assistance. If so, or if there is no response and the system detects unconscious occupants, 911 may be called. In this instance, the system will have a conversation with the 911 operator and convey information on behalf of the occupants. In the event one or more of the occupants are conscious, the system may facilitate the conversation between the occupants and the 911 operator, if necessary. For instance, the occupant may be conscious but not able to speak clearly or loudly enough for the 911 operator to hear them. The system may gather information from onboard cameras, microphones, and other sensors throughout the vehicle (seatbelt, engine, doors, seat occupant, etc.) and pass that on to the 911 operator.

Conversations with the 911 operator may be via voice and/or text-based messages. The Chatbot may have been trained to deal with these situations so it can actively and dynamically provide relevant information to the 911 operator-such as either proactively and/or in response to questions posed by the 911 operator.

After an accident, the EV may perform a self-diagnosis and determine if it is safe to move and if so, may take the occupants to the hospital or even meet EMS enroute to the hospital. In some scenarios, EMS may be close but not in the same direction as the hospital and the EV may opt to meet EMS, instead of taking the occupants directly to the hospital.

Regarding operation of an autonomous EV, some EVs have manual controls and/or may be manipulated by the “driver.” In this case, the Chatbot may engage in a conversation (and may even start the conversation) with regards to maximizing the range of the battery during a trip. This may be accomplished by merging various datapoints about the trip, vehicle, weather (temperature, precipitation, etc.), road conditions, immediate and upcoming traffic, location/geography, driving profile of the driver, vehicle profile, vehicle technical systems and capabilities, etc. Combining these data points may help the driver by giving tips to maximize range, such as reducing speed. Consequently, reduced speed may reduce risk of a collision, which obviously benefits drivers, passengers, and insurance providers.

By adhering to suggestions of the Chatbot, the insured may enjoy a discount on coverage for that trip with Usage-Based Insurance (UBI) or other products. Additionally or alternatively, the Chatbot may provide charging station location and cost information, as well as maintenance depot location and information.

The Chatbot may be used to provide route options to the occupants by engaging in a natural language manner to determine trip criteria (e.g., Where do you want to go? How soon do you need to be there? Do you want to avoid tolls, accidents, road construction, etc.?)

The present embodiments may include several models that utilize various inputs. For instance, an exemplary Information System Model may include inputs such as: (1) EV insurance product information system; (2) policy discount eligibility information; (3) general insurance information; (4) vehicle manufacturer insurance information (in case the vehicle manufacturer provides insurance); and/or (5) other information and data.

An exemplary 911 Operator Chatbot Model inputs may include: (1) crash video data; (2) occupancy video data; (3) crash audio data; (4) occupancy audio data; (5) natural language processing; (6) vehicle telemetry (or telematics) crash data; and/or (7) additional sensor and other data.

An exemplary Vehicle Performance Prediction Model (i.e., to maximize battery range for a trip) may include: (1) vehicle telemetry or telematics data (such as acceleration, braking, cornering, steering, direction, and/or GPS data); (2) location data; (3) geographical data; (4) weather data impacts on battery life, such as, for example, cold temperatures reduce the range of batteries; (5) precipitation data impacts on EV performance, such as traction implications (e.g., if it is raining/snowing, the system may suggest slowing down due to road conditions, which will also help extend range due to reduced speed) and implications of precipitation on EV sensor degradation (e.g., if it is snowing too hard, it may be determined whether the automation of the EV can safely operate the vehicle); and/or (6) additional sensor and other data.

An exemplary Charging Location, Availability & Cost Model may include information collected in real-time from the Internet, as well as other information. An exemplary Route Options Model may be leveraged with the present embodiments and used in a ChatGPT-based Chatbot to collect information from the user and providing options in a natural language way.

The present embodiments may include several outputs. For instance, the outputs may provide beneficial capabilities through natural conversation that: (1) help an insured with their EV policy coverage; (2) contact emergency personnel and potentially providing life-saving information; (3) provide helpful operational tips; (4) provide optimal route options based upon user defined criteria; and/or (5) provide other outputs, including those discussed elsewhere herein.

The present embodiments may provide a user with easy access to important information regarding coverage of their EV, and/or the ability to get/increase coverage. The user will be better protected in the event of a collision as the computer system may work with the 911 operator, even if the occupants of the EV cannot. This present functionality may go well beyond crash detection simply calling 911 as the Chatbot may engage in a rich conversation that provides pertinent and potentially life-saving information.

The computer system may also provide users with access to information about their EV and how to get the most performance out of it while at the same time lowering risk (and by extension, lowering cost to insurance providers) and where a discount is applicable, reducing cost to the insured.

### ChatGPT BOT for First Responders

Automobile crashes have the potential to trap the occupants inside the vehicle. Additionally, electric vehicles (EVs) may have a potential, or even a high potential, for the battery to catch fire in a crash.

Unlike conventional non-EVs, rescue personnel typically may not be able to easily cut an EV apart to rescue victims trapped inside after a crash due to the potential of electrocution from the high voltage of the battery pack embedded within the EV. Rescue personnel may not be adequately trained on each vehicle model/year to know where to safely cut or pry to avoid the high-voltage cables connected to the battery pack or otherwise running throughout the body of the EV.

This problem may cause delays in getting occupants out of a crashed EV before the battery catches fire, or at least before the occupants are injured, or even killed, by an already burning battery.

After a crash, rescue personnel may attempt to get the most information they can via the Internet, but typically they depend on their own personal smart phone and available cellular data, which may have sporadic or spotty coverage. The success of the rescue personal may also depend on the (i) rescue personnel's ability to effectively search the Internet for the required information, and (ii) availability of the information by the manufacturer of the applicable EV.

To assist rescue personnel in safely dismantling an EV in the event of a crash, the present embodiments may provide a ChatGPT-based Chatbot for first responders to query about where and where not to cut the particular model/year of EV, or even in general, as well as information regarding battery safety and likeliness of a fire. The conversation-like communication may allow for the user to tell the chatbot if a specific area cannot be dismantled for any reason, and the chatbot may provide alternative locations on the vehicle to cut (or otherwise pry apart) in real time.

The computer system may also ask for a picture or pictures of the damaged areas of a crashed vehicle that may be analyzed quickly, and a response may be returned to the user that already accounts for the damaged areas. When connected to a video camera, the computer system may also analyze the crashed/damaged vehicle in real-time. The system may provide specific instructions to first responders on how to proceed in extracting the occupants using a pre-trained model of vehicle and damage assessment.

When connected to Augmented Reality (AR) headset/goggles/glasses, the system may highlight where to cut and provide real-time feedback (even during the cut) about progress and potential dangers (these capabilities are all based upon pre-trained models and real-time video input). For instance, AR glasses may highlight or emphasis where or how to cut into the body of the EV.

When engaging with the user using a camera, the chatbot may use voice instead of writing text on a screen to be read. Additionally or alternatively, both voice and textual output and communication may be utilized with a user.

There may be several inputs to the computer system. For instance, exemplary inputs to the ML model may include collecting and compiling information on EVs regarding where the EV is and is not safe to cut apart an EV, as well as other pertinent information specific to EVs that would help reduce the time it takes to safely extract occupants from crashed EVs. The inputs to the computer system or an associated application may include: vehicle type, model, and year; and/or still or video images of the crashed EVs.

The outputs generated by the computer system or an associated application may include: (i) text-based or voice-based dialogue of safe locations to dismantle the vehicle depending on the state of the vehicle after the crash; (ii) helpful information regarding the type and dangers of the particular battery technology in the car (battery technologies will change over time); and/or (iii) training videos that may be used during non-emergency training time. Finally, the most important customer value here may be the reduced time it will take first responders to safely extract occupants from crashed EVs.

### Exemplary Functionality

The smart assistants may include a smart vehicle assistant that assists drivers or other occupants of a vehicle, for instance by providing insurance information, by providing tips to extend the battery life and/or travel range of the vehicle, and/or by assisting with a response to a collision involving the vehicle. The smart assistants may also, or alternately, include a smart responder assistant that assists a responder who is dispatched to respond to a collision involving the vehicle, for instance by providing information about electrical systems of the vehicle and recommendations regarding which portions of the vehicle are safest and/or quickest to cut to extract trapped occupants of the vehicle. The smart assistants may each include a chatbot (or voice bot) that a user may interact with to ask questions and/or receive information, for instance via a natural language conversion based upon text and/or audio input and output.

As example, a vehicle chatbot of the smart vehicle assistant may provide a user, associated with a vehicle, information indicating whether or not the vehicle is covered by an insurance policy that covers autonomous operations of the vehicle and/or other types of operations of the vehicle. The vehicle chatbot may also provide insurance quotes and/or bind changes to an insurance policy, for instance to add or adjust insurance coverage associated with the vehicle.

As another example, the vehicle chatbot may provide a user with recommendations for extending the battery life and/or travel range of an electric vehicle. For example, the vehicle chatbot may suggest that an electric vehicle travel at reduced speeds, travel along an alternate travel route, and/or otherwise adjust operations in a manner that is predicted to extend the battery life and/or travel range of an electric vehicle.

If the vehicle is involved in a collision, the vehicle chatbot may also initiate a 911 call or other emergency communication session on behalf of vehicle occupants who may be unconscious or otherwise unable to engage in the emergency communication session. For example, the vehicle chatbot may engage in a natural language conversation with a 911 operator, to provide information to the 911 operator and/or respond to questions from the 911 operator. In some situations, if the vehicle is an autonomous vehicle and a self-diagnosis indicates that the vehicle is still able to drive autonomously following the collision, the smart vehicle assistant may direct the vehicle to autonomously drive to a hospital or other location, so that occupants of the vehicle may obtain medical services or other assistance.

As another example, a responder chatbot of the smart responder assistant may provide a responder, who is dispatched to respond to a collision involving the vehicle, with information about the vehicle, recommendations regarding response actions to take to extract occupants trapped within the vehicle, and/or other types of output. For instance, based upon an identification of the vehicle, a damage estimate of the vehicle, and/or schematics of the vehicle, the responder chatbot and/or other elements of the smart responder assistant may indicate portions of the structure of the vehicle that may be unsafe to cut due to electrical cables and/or impaired structural components of the vehicle. The elements of the smart responder assistant may also recommend other portions of the vehicle that may quicker and/or safer to cut in order to extract trapped occupants.

### Exemplary Computing Environment

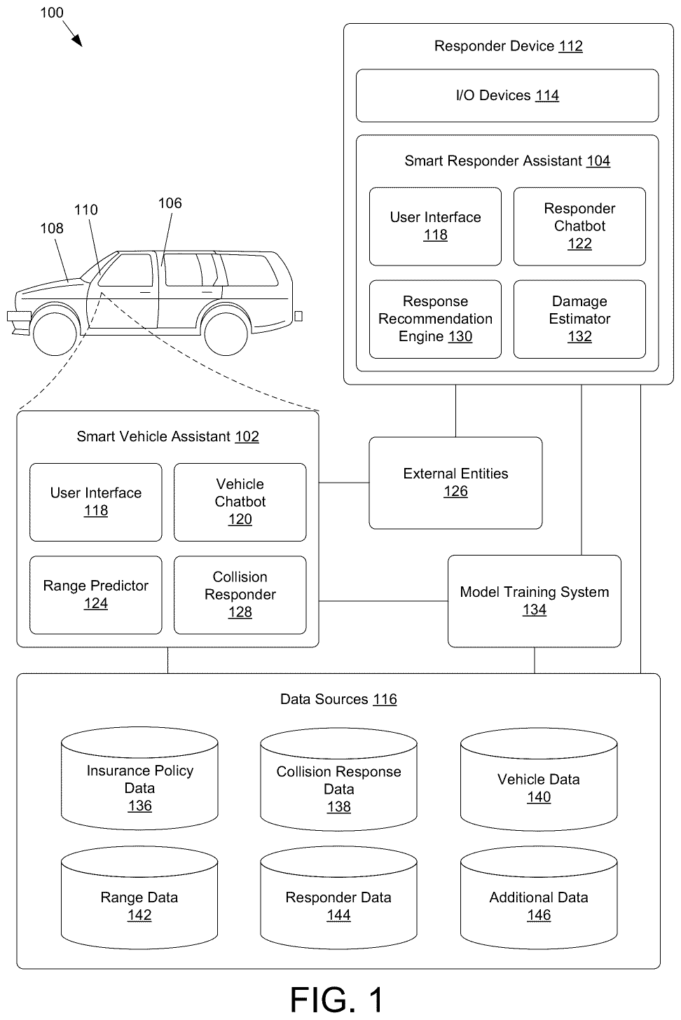

FIG. 1 shows an exemplary computing environment 100 associated with at least one of a smart vehicle assistant 102 or a smart responder assistant 104. The smart vehicle assistant 102 may be configured to assist one or more occupants of a vehicle 106, and/or other individuals or entities in association with the vehicle 106. The smart responder assistant 104 may assist one or more response entities, such emergency services personnel, during a response to a collision, accident, or other incident involving the vehicle 106. The smart vehicle assistant 102 and the smart responder assistant 104 may be computer-implemented systems that may receive data, such as user input, sensor data, and/or other data, and that may provide output to users and/or other elements proactively and/or in response to received input.

For example, as described further below, the smart vehicle assistant 102 may provide output associated with the vehicle 106 to occupants of the vehicle 106 and/or to other entities. Such output may include insurance information, battery range information, collision response information, and/or other types of information associated with the vehicle 106. The smart vehicle assistant 102 may also, or alternately, cause the vehicle 106 to perform actions autonomously in certain situations. For example, if the vehicle 106 is involved in a collision, and the smart vehicle assistant 102 determines that occupants of the vehicle 106 are unresponsive following the collision, the smart vehicle assistant 102 may cause the vehicle 106 to autonomously drive to a hospital or other destination.

The smart responder assistant 104 may assist emergency services personnel or other response in response to a collision or other incident involving the vehicle 106, for instance by providing a responder with information about the vehicle 106 and/or recommendations on how to respond to a collision involving the vehicle 106. For example, based upon electrical schematics associated with the vehicle 106, structural analysis of damage to the vehicle 106, and/or other information associated with the vehicle 106, the smart responder assistant 104 may provide output identifying portions of the structure of the vehicle that may be safest and/or most efficient to cut in order to extract occupants trapped in the vehicle 106.

The vehicle 106 may be a car, truck, or other type of vehicle. In some examples, the vehicle 106 may be an Electric Vehicle (EV), hybrid vehicle, or other type of vehicle that is at least partially powered by a battery 108. For instance, the battery 108 may be a lithium-ion (Li ion) battery, a lithium-ion polymer battery, a nickel-metal hydride (NiMH) battery, a lead-acid battery, a nickel cadmium (Ni—Cd) battery, a zinc-air battery, a sodium-nickel chloride battery, or another type of battery that may at least partially power the vehicle 106. Although the vehicle 106 may be at least partially powered by the battery 108 in some examples, in some examples the vehicle 106 may be at least partially powered by an Internal Combustion Engine (ICE) and/or other elements that consume fuel. For instance, the vehicle 106 may be a hybrid vehicle that is powered at different times by either or both the battery 108 and an ICE. In other examples, the vehicle 106 may be an EV that is fully electric and lacks an ICE.

In some examples, the vehicle 106 may be an autonomous or semi-autonomous vehicle. In these examples, operations of the machine, such as steering, acceleration, braking, and/or other operations, may be fully or partially controlled by an on-board computing system incorporated into the vehicle 106 and/or by other computing elements. In some examples, the vehicle 106 may be manually controlled by a driver, instead of or in addition to being autonomous or semi-autonomous. For instance, the vehicle 106 may have an autonomous mode in which the vehicle 106 drives autonomously without any input from a driver, a semi-autonomous mode in which the vehicle 106 drives semi-autonomously with minimal or infrequent input from a driver, and/or a manual mode in which the vehicle 106 is driven based upon input from a driver.

The vehicle 106 may have one or more sensors 110 that are configured to capture corresponding types of sensor data, user input, or other input data. The sensors 110 may include accelerometers and/or other motion sensors, Global Positioning System (GPS) sensors and/or other location sensors, sensors associated with a transmission and/or braking system of the vehicle 106, cameras and/or other image-based sensors, Light Detection and Ranging (LiDAR) sensors, microphones, proximity sensors, weight sensors, seatbelt sensors, seat pressure sensors, payload sensors, and/or other types of sensors. Sensor data, user input, and/or other input data captured by the sensors 110 may be provided to an on-board computing system of the vehicle 106, for instance such that the on-board computing system may perform autonomous or semi-autonomous operations based upon received sensor data. In some examples, as described herein, sensor data, user input, and/or other input data captured by the sensors 110 may also, or alternately, be provided to the smart vehicle assistant 102, such that the smart vehicle assistant 102 may operate based upon the sensor data, user input, and/or other input data.

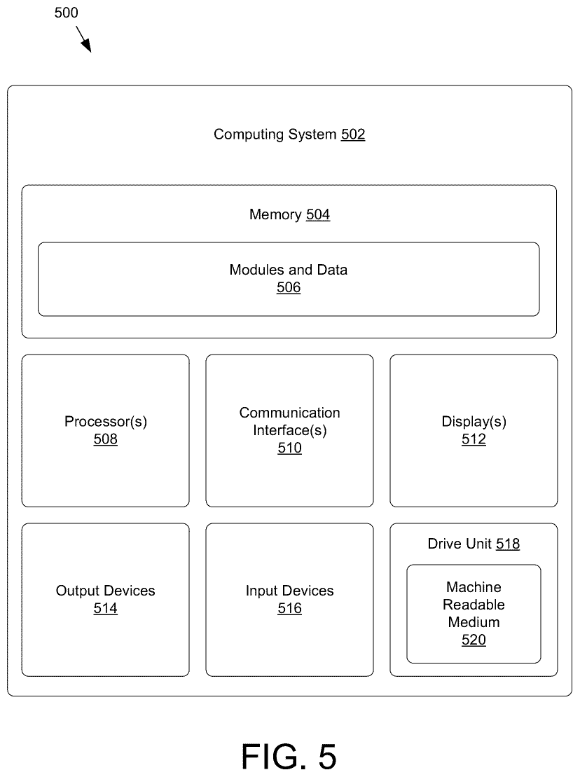

The smart vehicle assistant 102 and the smart responder assistant 104 may be executed by one or more computing systems, as discussed further below. An exemplary architecture of a computing system that may execute one or more elements of the smart vehicle assistant 102 or the smart responder assistant 104 is shown in FIG. 5, and is discussed further with respect to that figure.

In some examples, the smart vehicle assistant 102 may be executed at least in part via one or more computing systems that are integrated into the vehicle 106. For example, the vehicle 106 may have one or more on-board processors that may execute one or more elements of the smart vehicle assistant 102. In these examples, a user inside the vehicle 106, such as a driver or other occupant, may use the smart vehicle assistant 102 via a dashboard display of the vehicle 106, integrated speakers and/or microphones of the vehicle 106, and/or other elements of the vehicle 106.

In other examples, the smart vehicle assistant 102 may be executed at least in part via one or more computing systems that are different and/or separate from the vehicle 106. As an example, one or more portions of the smart vehicle assistant 102 may be executed via a mobile phone, computer, or other computing device used by a user. As another example, a user may use a mobile phone, computer, or other computing device to access elements of the smart vehicle assistant 102 that are executed by a remote server, a cloud computing environment, and/or other computing systems. For instance, one or more elements of the smart vehicle assistant 102 may be accessible via a webpage, web portal, or other resource that a user may access over the Internet and/or other networks via a user device.

In some examples, elements of the smart vehicle assistant 102 may be distributed among, and/or be executed by, multiple computing systems. As an example, some elements of the smart vehicle assistant 102 may be executed via an on-board computing system of the vehicle 106 and/or a mobile phone of a user, while other elements of the smart vehicle assistant 102 may be executed via a remote server, a cloud computing environment, and/or other computing systems that may exchange data with the on-board computing system of the vehicle 106 and/or the mobile phone of the user via one or more networks. As another example, the smart vehicle assistant 102 may execute at least in part as an application that executes on a mobile user device, and the user may interact with the application via a dashboard system of the vehicle 106 when the user device is connected to the dashboard system via Apple CarPlay®, Android Auto™, or other systems.

The smart responder assistant 104 may similarly be executed and/or accessed via one or more computing systems, such as via a responder device 112. In some examples, the responder device 112 may be a mobile phone, laptop computer, an Augmented Reality (AR) headset, or other mobile computing device that may be transported by a responder to the scene of an accident or other incident involving the vehicle 106. The responder device 112 may have input/output (I/O) devices 114, such as one or more screens, speakers, microphones, cameras, a keyboard, a keypad, and/or other types of I/O devices. Such I/O devices 114 may capture user input, sensor data, and/or other types of input data that may be provided to and/or processed by the smart responder assistant 104, and/or that may be used to present output of the smart responder assistant 104 to a user.

In some examples, one or more portions of the smart responder assistant 104 may be executed locally via the responder device 112, and/or the responder device 112 may access elements of the smart responder assistant 104 that are executed by a remote server, a cloud computing environment, and/or other computing systems. For instance, one or more elements of the smart responder assistant 104 may be accessible via a webpage, web portal, or other resource that a user of the responder device 112 may access over the Internet and/or other networks via the responder device 112.

In other examples, the responder device 112 may be an on-board computing system of a firetruck, ambulance, or other response vehicle that may travel to the scene of an accident or other incident involving the vehicle 106. In these examples, a user inside the response vehicle may use the smart responder assistant 104 via a dashboard display of the response vehicle, integrated speakers and/or microphones of the vehicle response vehicle, and/or other elements of the response vehicle.

In some examples, elements of the smart responder assistant 104 may be distributed among, and/or be executed by, multiple computing systems. As an example, some elements of the smart responder assistant 104 may be executed via the responder device 112, while other elements of the smart responder assistant 104 may be executed via a remote server, a cloud computing environment, and/or other computing systems that may exchange data with the responder device 112. As another example, the smart responder assistant 104 may execute at least in part as an application that executes on a mobile user device, and a user may interact with the application via a dashboard system of a response vehicle when the user device is connected to the dashboard system via Apple CarPlay®, Android Auto™, or other systems.

Overall, the smart vehicle assistant 102 and the smart responder assistant 104 may receive one or more types of input, such as user input, sensor data, and/or other data. In some examples, the smart vehicle assistant 102 and the smart responder assistant 104 may also access, and/or receive input from, one or more other data sources 116. The smart vehicle assistant 102 and the smart responder assistant 104 may use such input to determine corresponding output to be presented to users and/or other systems or entities.

As an example, the smart vehicle assistant 102 may receive user input and/or sensor data captured by one or more types of sensors 110 of the vehicle 106 and/or a user device associated with smart vehicle assistant 102. The smart responder assistant 104 may similarly receive user input and/or sensor data captured by I/O devices 114 of the responder device 112. User input may be received from one or more users or other entities that interact with the smart vehicle assistant 102 or the smart responder assistant 104. In some examples, user input may be provided as text input, for instance via a user device, a vehicle dashboard system, and/or another interface. The user input may also, or alternately, be provided as audio data via a microphone of a user device, a vehicle, or another system. The user input may also, or alternately, be provided as image and/or video data via a camera of a user device, a vehicle, or another system. The user input may also, or alternately, be provided as user selections of options presented by the smart vehicle assistant 102 or the smart responder assistant 104, and/or any other type of user input.

The smart vehicle assistant 102 and the smart responder assistant 104 may have a user interface 118 that present information to users, and/or that accepts user input from the users. In some examples, a user interface 118 may be a graphical user interface (GUI) that may be displayed via a screen. For instance, the user interface 118 of the smart vehicle assistant 102 may be displayed via a dashboard screen of the vehicle 106 or a screen of a user device. Similarly, the user interface 118 of the smart responder assistant 104 may be displayed via a screen of the responder device 112.

In other examples, a user interface 118 may include a non-visual interface, such as an audio-based interface. Accordingly, the smart vehicle assistant 102 and/or the smart responder assistant 104 may present or convey information to users via audio with or without also displaying the information visually via a screen. As an example, the smart vehicle assistant 102 may be an audio-based system that may receive user input as audio voice input captured by a microphone of the vehicle 106 or a user device, and that May audibly present corresponding output voice data via speakers of the vehicle 106 or the user device. Accordingly, in these examples, a user of the smart vehicle assistant 102 may have a voice-based audio conversation with the smart vehicle assistant 102 instead of, or in addition to, interacting with the smart vehicle assistant 102 via a screen or other visual interface. Similarly, a user of the smart responder assistant 104 may have a voice-based audio conversation with the smart responder assistant 104 instead of, or in addition to, interacting with the smart responder assistant 104 via a screen or other visual interface.

In certain embodiments, the smart vehicle assistant 102, the smart responder assistant 104, and/or user interfaces 118 of the smart vehicle assistant 102 and/or the smart responder assistant 104 may include or comprise one or more local or remote processors, servers, transceivers, sensors, memory units, mobile devices, wearables, smart watches, smart contact lenses, smart glasses, Augmented Reality (AR) glasses, Virtual Reality (VR) headsets, mixed or extended reality glasses or headsets, voice bots, chatbots, ChatGPT or ChatGPT-based bots, and/or other electronic or electrical components, which may be in wired or wireless communication with one another. For instance, in one embodiment, a chatbot associated with the smart vehicle assistant 102 may provide information to a user (and/or receive information or input from the user), such as driving or steering directions and/or questions, via AR glasses and/or the chatbot. Similarly, in another embodiment, a chatbot associated with the smart responder assistant 104 may provide information to a user (and/or receive information or input from the user), such as response action directions and/or questions, via AR glasses and/or the chatbot.

The smart vehicle assistant 102 and/or the smart responder assistant 104 may have chatbots that may process input, such as user input, sensor data, information from data sources 116, and/or other data, and generate corresponding responses and/or other output. For example, the smart vehicle assistant 102 may have a vehicle chatbot 120, and the smart responder assistant 104 may have a responder chatbot 122, as discussed further below. Accordingly, in some examples, users of the smart vehicle assistant 102 and the smart responder assistant 104 may respectively engage in voice-based and/or text-based conversations with the smart vehicle assistant 102 and the smart responder assistant 104 via the chatbots. The chatbots may, in some examples, also include or be known as voice bots.

As an example, an occupant of the vehicle 106 may interact with the vehicle chatbot 120 of the smart vehicle assistant 102 to inquire about insurance coverage associated with the vehicle 106, and/or ways of extending the vehicle's range based upon the battery 108 and other factors. The vehicle chatbot 120 may respond by providing insurance coverage information and/or battery range tips to the user. In some examples, battery range tips presented to the user may be generated by a range predictor 124 of the smart vehicle assistant 102, and/or be derived from information determined by the range predictor 124, as discussed further below.

As another example, if the vehicle 106 is in a collision, the vehicle chatbot 120 may interact with one or more occupants of the vehicle 106, and/or may interact with external entities 126 in response to the collision on behalf of the occupants. Such external entities 126 may include an insurance company, a Public Safety Answering Point (PSAP) or other emergency services call center, other emergency services entities, emergency contacts of the occupants, and/or other entities. For instance, as discussed further below, the vehicle chatbot 120 may interact with occupants of the vehicle 106 following a collision to obtain information about the health and safety of the occupants, and/or the vehicle chatbot 120 may communicate with emergency services on behalf of the occupants.

In some examples, the vehicle chatbot 120 may generate output associated with a collision based in part on a collision responder 128 of the smart vehicle assistant 102, as discussed further below. For instance, the vehicle chatbot 120 may, based upon the collision responder 128, ask questions to occupants of the vehicle 106 following the collision, and/or provide instructions that direct the occupants to perform actions in response to the collision. In some situations, a responder associated with the responder device 112 may be dispatched by a PSAP or other external entity 126 to respond to the collision, as discussed further below.

As another example, if the vehicle 106 is involved in a collision, a user of the smart responder assistant 104 may interact with the responder chatbot 122 to provide information about the vehicle 106. The responder chatbot 122 may provide corresponding recommendations to the user regarding how to respond to the collision, for instance regarding how to most safely and/or most quickly extract occupants who may be trapped in the vehicle 106 due to the collision. In some examples, response recommendation output presented via the responder chatbot 122 may be based upon determinations made by a response recommendation engine 130 of the smart responder assistant 104, and/or may be based upon a damage estimate of the vehicle 106 generated by a damage estimator 132 of the smart responder assistant 104, as discussed further below.

A chatbot, such as the vehicle chatbot 120 or the responder chatbot 122, may be based upon a generative Artificial Intelligence (AI) system that may generate natural language text and/or audio responses to input data, such that a user may converse with the chatbot naturally by asking free-form questions or making other natural language statements, and receiving corresponding natural language responses generated by the chatbot instead of, or in addition to, prewritten responses or predetermined information. The chatbot may generate natural language output that expresses information conversationally via serious and/or humorous statements, that responds to statements and/or questions input by the user most recently and/or earlier during a conversation, that poses questions to the user, and/or that otherwise converses with the user.

In examples in which user input is audio-based voice data, a chatbot and/or other elements of the smart vehicle assistant 102 or the smart responder assistant 104 may use voice-to-text systems, Natural Language Processing (NLP), and/or other types of audio processing to interpret the audio-based voice data provided by the user. In other examples in which user input is text-based, a chatbot and/or other elements of the smart vehicle assistant 102 or the smart responder assistant 104 may similarly use NLP and/or other types of text processing systems to interpret text provided by a user.

In some examples, a chatbot or voice bot, such as the vehicle chatbot 120 or the responder chatbot 122, may be based upon a generative pre-trained transformer (GPT) model and/or a large language model. The voice bots and/or chatbots discussed herein may be configured to utilize AI (artificial intelligence) and/or ML (machine learning) techniques. For instance, a chatbot may be a large language model such as OpenAI GPT-4, Meta LLaMa, or Google PaML 2. The voice bots and/or chatbots discussed herein may, for example, be similar to GPT-based models such as ChatGPT®. The voice bots and/or chatbots discussed herein may employ supervised or unsupervised ML techniques, which may be followed by, and/or used in conjunction with, reinforced or reinforcement learning techniques. The voice bots and/or chatbots may employ the techniques utilized for ChatGPT.

One or more models associated with the vehicle chatbot 120, other elements of the smart vehicle assistant 102, the responder chatbot 122, and/or other elements of the smart responder assistant 104 may be trained by a model training system 134 using supervised learning, reinforcement learning, and/or other machine learning techniques. For example, one or more models associated with a chatbot may be trained, by the model training system 134, based upon a training dataset. As discussed further below, a training dataset used by the model training system 134 to train a chatbot may be based upon one or more types of information that may be provided and/or maintained by one or more data sources 116. The data sources 116 may include insurance policy data 136, collision response data 138, vehicle data 140, range data 142, responder data 144, and/or additional data 146. Accordingly, the chatbot may be trained to provide information indicated by, and/or derived from, one or more data sources 116 during conversations with users, and/or to steer the conversations towards such information as described further below.

The model training system 134 may be a computer-executable system that is configured to train one or more models associated with one or more chatbots, such as the vehicle chatbot 120 or the responder chatbot 122. The model training system 134 may also be configured to train one or more models associated with other elements that interact with one or more chatbots. As an example, the model training system 134 may train the range predictor 124, the collision responder 128, and/or other elements of the smart vehicle assistant 102 that interact with the vehicle chatbot 120. As another example, the model training system 134 may train the response recommendation engine 130, the damage estimator 132, and/or other elements of the smart responder assistant 104 that interact with the responder chatbot 122.

In some examples, the model training system 134 may be at least partially separate from the smart vehicle assistant 102 and/or the smart responder assistant 104, and may execute to train and/or re-train instance of the vehicle chatbot 120 and/or the responder chatbot 122. A trained instance of the vehicle chatbot 120 may accordingly be deployed in the smart vehicle assistant 102, and a trained instance of the responder chatbot 122 may accordingly be deployed in the smart responder assistant 104. The model training system 134 may train a chatbot, such as the vehicle chatbot 120 or the responder chatbot 122, to generate conversational statements and/or other output during a conversation proactively and/or in response to user questions or statements. The chatbot may generate such statements or other output based upon information that was in a training dataset at the time the chatbot was trained and/or based upon other information that may be accessed by the chatbot.

As discussed above, the model training system 134 may train one or more models associated with a chatbot, such as the vehicle chatbot 120 or the responder chatbot 122, via supervised learning, reinforcement learning, and/or other machine learning techniques. For example, the model training system 134 may train a chatbot based upon supervised learning using labeled data within a training dataset, such that the training causes the chatbot to predict which labeled data is responsive to example user questions.

The chatbot may also be trained to generate statements in response to example user questions, and the statements generated by the chatbot during the training process may be manually reviewed via the model training system 134 to determine whether the statements generated by the chatbot adequately respond to the example user questions. For instance, manual feedback may indicate whether or not statements generated by the chatbot covered accurate and relevant information, sufficiently responded to the example user questions, and/or were readable and understandable by humans. Feedback provided during such manual review may be used via Reinforcement Learning from Human Feedback (RLHF) techniques to further train or retrain the chatbot.

After a chatbot has been trained or re-trained via the model training system, a trained instance of the chatbot may be deployed. For example, a trained instance of the vehicle chatbot 120 may be deployed in the smart vehicle assistant 102, such that the vehicle chatbot 120 may engage in conversions with occupants of the vehicle 106 and/or engage in conversations with other users and/or external entities 126 in association with the vehicle 106. Similarly, a trained instance of the responder chatbot 122 may be deployed in the smart responder assistant 104, such that the responder chatbot 122 may engage in a conversation with a responder or other user of the responder device 112 who responds to a collision or other incident involving the vehicle 106.

Statements and/or other output generated by chatbots during such conversations may be based upon information that was in corresponding training datasets when the chatbots were trained. Such training datasets may, for example, include information stored in, and/or provided by, one or more data sources 116. Statements and/or other output generated by the chatbots during such conversations may also, or alternately, be based upon similar or additional information that is stored locally and/or may be accessed via a network from the one or more data sources 116. As discussed above, the data sources 116 may include insurance policy data 136, collision response data 138, vehicle data 140, range data 142, responder data 144, and/or additional data 146.

In some examples, a training dataset used to train the vehicle chatbot 120 and/or other elements of the smart vehicle assistant 102 may include information from the insurance policy data 136, the collision response data 138, the vehicle data 140, the range data 142, the additional data 146, and/or other data. Additionally, in some examples, a training dataset used to train the responder chatbot 122 and/or other elements of the smart responder assistant 104 may include information from the vehicle data 140, the responder data 144, the additional data 146, and/or other data. However, in other examples, training datasets used to train the vehicle chatbot 120, the responder chatbot 122, and/or other elements of the smart vehicle assistant 102 and the smart responder assistant 104 may include other and/or different types of information.

The insurance policy data 136 may indicate information associated with insurance coverage provided and/or offered by an insurance company, existing insurance policies provided by the insurance company, rates and/or options for adjusting insurance coverage associated with insurance policies, and/or other information. In some examples, the insurance coverage may be Usage-Based Insurance (UBI), such as insurance coverage that is billed based at least in part on how much and/or how often a vehicle is driven. The insurance policy data 136 may be maintained in one or more databases or other data repositories, for instance in one or more databases maintained by an insurance company that are accessible by the model training system 134 and/or the smart vehicle assistant 102. As an example, the operator of the model training system 134 and/or the provider of the smart vehicle assistant 102 may be, or may be associated with, the insurance company that maintains the insurance policy data 136.

The collision response data 138 may indicate information associated with responses to collisions, involving one or more vehicles, by the vehicles and/or by occupants of the vehicles. As an example, the collision response data 138 may define what types of information should be reported to emergency services, an insurance company, and/or other external entities 126 in the event of a vehicle collision. As another example, the collision response data 138 may include example scripts for communicating with occupants of a vehicle and/or a PSAP or another external entity 126 following a vehicle collision.

As yet another example, the collision response data 138 may include rules or criteria indicating when and/or if a vehicle may leave the scene of a collision. For instance, the collision response data 138 may indicate that a vehicle may leave the scene of a collision to transport vehicle occupants to a hospital if the collision was a single-vehicle collision that did not involve any other vehicles, and/or after sensor data captured before, during and/or after the collision has been transmitted to emergency services, an insurance company, and/or other external entities 126.

The collision response data 138 may be a set of media that is generated, compiled, and/or curated by an operator of the model training system 134 and/or a provider of the smart vehicle assistant 102. For example, if the operator of the model training system 134 and/or a provider of the smart vehicle assistant 102 is an insurance company, the insurance company may generate and/or curate the collision response data 138 such that the collision response data 138 conveys information about how to respond to a collision that has been approved by the insurance company.

The vehicle data 140 may include information about particular types of vehicles. For example, the vehicle data 140 may indicate, for a particular make and model of a vehicle, and for a particular model year, which type of battery 108 the vehicle uses and/or electrical schematics indicating locations of high-voltage cables and/or other electrical elements within the physical structure of the vehicle. The vehicle data 140 may also indicate structural information and/or schematics of vehicles, information about weights and dimensions of vehicles, information about acceleration capabilities of vehicles, information about braking capabilities of vehicles, and/or other information about vehicles. The vehicle data 140 may be maintained in one or more databases or other data repositories, for instance in one or more databases maintained by manufacturers of vehicles, an operator of the model training system 134, and/or a provider of the smart vehicle assistant 102 and/or the smart responder assistant 104.

The range data 142 may include information about how far vehicles powered by batteries are able to travel based upon State of Charge (SoC) levels of the batteries and/or other factors. For example, the range data 142 may include historical data indicating how SoC levels of vehicle batteries change over time, and/or how far vehicles have been able to travel based upon power from such vehicle batteries, in association with travel speeds, travel routes, traffic patterns along the travel routes, capabilities of vehicles, and/or other factors. The range data 142 may also include example scripts for communicating tips regarding extending travel ranges and/or battery SoC levels to users of the vehicle chatbot 120. The range data 142 may be maintained in one or more databases or other data repositories, for instance in one or more databases maintained by manufacturers of vehicles and/or batteries, an operator of the model training system 134, and/or a provider of the smart vehicle assistant 102.

The responder data 144 may include information regarding how responders have, and/or should, respond to vehicle collisions or other incidents. For example, the responder data 144 may include historical data indicating how actions of responders to cut into physical structures of vehicles to extract occupants of vehicles have impacted the total time taken to extract those occupants. For instance, the responder data 144 may indicate that historically, cutting through a side door of a vehicle has resulted in quicker occupant extractions than cutting through a roof of a vehicle. The responder data 144 may also include videos, text articles, and/or other media that may be used to train responders to respond to vehicle collisions. The responder data 144 may be maintained in one or more databases or other data repositories, for instance in one or more databases maintained by emergency services providers, an operator of the model training system 134, and/or a provider of the smart responder assistant 104.

The additional data 146 may include one or more other types of information, such as weather data, traffic data, map data, image and/or audio data associated with collisions of vehicles, image and/or audio data associated with occupants of vehicles before, during, and/or after collisions, steering and driving data, and/or other types of data. The additional data 146 may be maintained in one or more databases or other data repositories, for instance in one or more databases maintained by an insurance company, an operator of the model training system 134 and/or a provider of the smart vehicle assistant 102 and/or the smart responder assistant 104.

Overall, the model training system 134 may train chatbots, such as the vehicle chatbot 120 and the responder chatbot 122, on training data associated with one or more data sources 116, such that the chatbots may hold conversations about corresponding topics with users of the smart vehicle assistant 102 and/or the smart responder assistant 104. In some examples, the vehicle chatbot 120 and/or the responder chatbot 122 may also access and/or use data from one or more data sources 116 during conversations with users, including information that was and/or was not used to train the chatbots.

The chatbots may also interact with other components in association with such conversations. For example, the vehicle chatbot 120 may interact with the range predictor 124 and/or collision responder 128 in association with one or more conversations, for instance to provide input to the range predictor 124 and/or the collision responder 128, and/or to present output from the range predictor 124 and/or the collision responder 128 during conversations. As another example, the responder chatbot 122 may interact with the response recommendation engine 130 and/or damage estimator 132 in association with one or more conversations, for instance to provide input to the response recommendation engine 130 and/or damage estimator 132, and/or to present output from the response recommendation engine 130 and/or damage estimator 132 during conversations.

### Exemplary Smart Vehicle Assistant Usage

The vehicle chatbot 120 of the smart vehicle assistant 102 may be configured as described above to engage in conversation with one or more users associated with the vehicle 106. As an example, a user of the vehicle chatbot 120 may be an occupant of the vehicle 106. As another example, a user of the vehicle chatbot 120 may be an owner of the vehicle 106, or another user associated with the vehicle 106, who interacts with the smart vehicle assistant 102 from outside the vehicle 106. As yet another example, a user of the vehicle chatbot 120 may be an external entity 126, such as an insurance company or PSAP, that the vehicle chatbot 120 engaged in conversation on behalf of an occupant or other entity associated with the vehicle 106. As described herein, the vehicle chatbot 120 may be configured to engage in a natural language conversations with one or more users via text, audio, and/or other types of media.

The vehicle chatbot 120 may be configured to provide insurance-related information, and/or cause changes to an insurance policy, based upon a conversation with a user of the smart vehicle assistant 102. For example, a user of the smart vehicle assistant 102 may be policyholder that has an insurance policy with an insurance company, and the insurance policy data 136 may include information about the user's insurance policy. However, the user may be unsure about coverage limits, rates, and/or other attributes of the user's current insurance policy, be unsure whether the vehicle 106 is covered by the user's current insurance policy, and/or be unsure about other aspects of the user's current insurance policy. As another example, if the vehicle 106 is an autonomous vehicle, the user may be unsure whether a current insurance policy held by the user covers autonomous vehicles, or whether an insurance policy held by a manufacturer or other provider of the autonomous vehicle covers autonomous operations of the vehicle 106. As yet another example, the user may be unsure how to add or adjust insurance coverage associated with the vehicle 106. Accordingly, the user may ask questions about such topics to the vehicle chatbot 120.

The vehicle chatbot 120 may respond, during the conversation, with information specific to an insurance policy that is associated with the user and/or that covers the vehicle 106, based upon the insurance policy data 136. For example, if a user does not know whether the user's current insurance policy covers autonomous operations of the vehicle 106, the user may ask the vehicle chatbot 120. The vehicle chatbot 120 may accordingly respond, based upon the insurance policy data 136, by providing output indicating whether the user's current insurance policy does or does not cover autonomous operations of the vehicle 106.

In some examples, if an existing insurance policy does not cover certain operations of the vehicle 106, the vehicle chatbot 120 may be configured to generate and present an insurance quote for adding or adjusting an insurance policy to add coverage for such operations of the vehicle 106. For example, if an existing insurance policy does not cover autonomous operations of the vehicle 106, the vehicle chatbot 120 may generate and/or present an insurance quote for adding or adjusting an insurance policy to add coverage for autonomous operations of the vehicle 106. In some examples, the vehicle chatbot 120 may suggest or recommend Usage-Based Insurance (UBI) coverage to a user, for instance based upon sensor data and/or other information indicating how often the vehicle 106 is driven autonomously, semi-autonomously, and/or manually.

The vehicle chatbot 120 may be trained based upon insurance policy data 136 to determine coverage limits, premiums, and/or other attributes of an insurance quote, for instance based upon other current and/or historical insurance policies indicated by the insurance policy data 136 that are associated with the same or similar types of vehicles, are associated with a similar geographic location and/or other demographics of a user, are associated with similar insurance claim histories as a user, and/or other data. In other examples, an insurance quote for adding or adjusting an insurance policy may be generated by other systems associated with an insurance company, but may be presented to a user via the vehicle chatbot 120. In some examples, a user may also provide user input accepting a new insurance quote presented via the vehicle chatbot 120, and the smart vehicle assistant 102 may submit information to servers and/or other systems of the insurance company that maintain the insurance policy data 136 in order to bind an insurance policy and/or make changes to an insurance policy based upon an accepted insurance quote.

The vehicle chatbot 120 may also, or alternately, be configured to provide range-related information during a conversation with a user of the smart vehicle assistant 102. As discussed above, the vehicle chatbot 120 may be associated with the range predictor 124 of the smart vehicle assistant 102, such that a user may interact with the range predictor 124 via the vehicle chatbot 120 during a conversation, and/or the vehicle chatbot 120 may provide information to the user during the conversation based upon determinations and/or predictions made by the range predictor 124. The range predictor 124 may be configured to estimate and/or predict a current range of the vehicle 106 based upon a current SoC of the battery 108, a planned travel route, current and/or expected travel speeds of the vehicle 106 along the planned travel route, current and/or expected traffic conditions along the planned travel route, current and/or expected weather conditions along the planned travel route, and/or other factors. The range predictor 124 may also be configured to estimate and/or predict how the SoC of the battery 108 and/or the corresponding range of the vehicle 106 would change based upon alternate travel routes, changes to current travel speeds, and/or other variables.

Accordingly, a user may inquire about a current travel range of the vehicle 106 via the vehicle chatbot 120, and the vehicle chatbot 120 may present information about the current travel range that is generated by the range predictor 124. In some examples, the vehicle chatbot 120 may ask the user questions about when and where the user plans to travel via the vehicle 106, what time the user wants to arrive at a destination, whether the user wants to avoid tolls, heavy traffic, accidents, and/or other elements along a route, and/or other information, such that the vehicle chatbot 120 or other elements of the smart vehicle assistant 102 may suggest a route for the user and determine a corresponding travel range to be presented via the vehicle chatbot 120. In other examples, the vehicle chatbot 120 or other elements of the smart vehicle assistant 102 may obtain information about a current or planned travel route via a GPS system of the vehicle or a connected user device, such that the range predictor 124 may generate range predictions that may be presented to the user via the vehicle chatbot 120.

The vehicle chatbot 120 may also, or alternately, provide the user with tips on how to extend the range of the vehicle 106 and/or preserve battery life of the vehicle 106, for instance by suggesting an alternate travel route, by suggesting that the vehicle 106 travel at reduced speeds, and/or by suggesting other adjustments to operations of the vehicle 106 that, based upon output of the range predictor 124, is expected to extend the range of the vehicle 106 and/or preserve battery life of the vehicle 106. The vehicle chatbot 120 may provide such tips to a user proactively during a conversation, and/or in response to user questions or statements during a conversation indicating that the user may be interested in extending the range of the vehicle 106 and/or preserving battery life of the vehicle 106.

The range predictor 124 may be a component of the vehicle chatbot 120, or may be a separate machine learning model, a separate rules-based model, or another separate system that may interact with users via the vehicle chatbot 120. For example, the range predictor 124 may be a machine learning model that based upon convolutional neural networks, recurrent neural networks, other types of neural networks, nearest-neighbor algorithms, regression analysis, deep learning algorithms, Gradient Boosted Machines (GBMs), Random Forest algorithms, and/or other types of artificial intelligence or machine learning frameworks. The model training system 134 may train the range predictor 124 based upon one or more types of data, such as the vehicle data 140, the range data 142, and/or the additional data 146. For example, the model training system 134 may train the range predictor 124 based upon historical data associated with battery types, battery SoC levels, travel routes, traffic levels, weather conditions, and/or other factors that correspond with known travel ranges indicated in the historical data.

Accordingly, based upon information about a type of the battery 108 of the vehicle 106, a current SoC of the battery 108, a particular travel route, current or expected traffic and/or weather conditions along the particular travel route, a current or expected travel speed of the vehicle 106 along the particular travel route, a historical driving profile of the driver of the vehicle 106, and/or other factors, the range predictor 124 may predict how far the vehicle 106 may travel and/or how much of the SoC of the battery 108 will be used during travel. Similarly, the range predictor 124 may predict how changes, such as alternate routes with different geographies, traffic patterns, weather conditions, and/or other factors that differ relative to factors associated with current travel route, adjustments to increase or decrease travel speeds of the vehicle 106, and/or other changes relative to current or expected operations of the vehicle 106, would change how far the vehicle 106 may travel and/or how much of the SoC of the battery 108 would be used during travel.

The vehicle chatbot 120 may accordingly provide such information to a user during a conversation, proactively and/or in response to user statements or questions. For example, the vehicle chatbot 120 may provide suggestions to the user regarding actions that may extend the range of the vehicle 106 and/or preserve battery life of the vehicle 106, based upon predictions associated with alternate routes and/or other alternate actions generated by the range predictor 124.

In some examples, the range predictor 124 may predict how current and/or expected weather conditions may impact traction of the vehicle, and also how such impacts may impact travel range and battery life. Similarly, the range predictor 124 or other elements of the smart vehicle assistant 102 may predict how current and/or expected weather conditions may impact abilities of sensors 110 of the vehicle 106 to capture sensor data that may be used by autonomous or semi-autonomous operations of the vehicle 106. The vehicle chatbot 120 may provide corresponding suggestions to the user, such as suggestions to slow travel speeds during heavy precipitation due to expected decreases in traction and/or decreased visibility.

In some examples, if the vehicle chatbot 120 provides suggestions to a user regarding how to adjust operations of the vehicle 106 to extend the travel range and/or battery life of the vehicle 106 during a trip, and the user follows those suggestions, the smart vehicle assistant 102 may provide a corresponding notification to an insurance company. The insurance company may therefore adjust the insurance policy data 136, for instance to provide a discount on the user's insurance policy, such as a discount on usage-based insurance rates associated with the trip, because the user followed the range-extending suggestions presented via the vehicle chatbot 120 in association with the trip.

In some examples, the vehicle chatbot 120 may also, or alternately, provide information about battery charging stations along a planned route and/or potential alternate routes, such as locations of the battery charging stations, costs associated with using the battery charging stations, and/or other information. For instance, as the user is driving the vehicle 106, the user may notice that the battery 108 of the vehicle 106 should soon be recharged, and may ask the vehicle chatbot 120 where the nearest battery charging station is located.

The vehicle chatbot 120 may also, or alternately, be configured to respond to a collision involving the vehicle 106, for instance by engaging in a conversation with one or more occupants of the vehicle 106 and/or by engaging in conversations with one or more external entities 126. As discussed above, the vehicle chatbot 120 may be associated with the collision responder 128 of the smart vehicle assistant 102, such that the vehicle chatbot 120 may engage in one or more conversations in response to a collision based at least in part on determinations made by the collision responder 128.

The collision responder 128 may be a component of the vehicle chatbot 120, or may be a separate machine learning model, a separate rules-based model, or another separate system that may interact with users via the vehicle chatbot 120. For example, the collision responder 128 may be a machine learning model that based upon convolutional neural networks, recurrent neural networks, other types of neural networks, nearest-neighbor algorithms, regression analysis, deep learning algorithms, GBMs, Random Forest algorithms, and/or other types of artificial intelligence or machine learning frameworks. The model training system 134 may train the collision responder 128 based upon one or more types of data, such as the collision response data 138, the vehicle data 140, and/or the additional data 146. For example, the model training system 134 may train the collision responder 128 based upon historical data associated with previous collisions, and/or responses to previous collisions by vehicles and/or occupants of the vehicles.

The collision responder 128 may be configured to detect when the vehicle 106 is involved in a collision, for instance based upon accelerometer data or other motion data indicating a sudden decrease in travel speed, based upon camera data and/or microphone data that is indicative of a collision, and/or other types of data. The collision responder 128 may also be configured to detect whether occupants of the vehicle 106 are conscious and/or responsive following a collision. For instance, the collision responder 128 may be configured to use camera data, microphone data, and/or motion sensor data to determine whether occupants of the vehicle 106 are moving, or are stationary and may be unconscious, following a detected collision.

If the collision responder 128 detects that the vehicle 106 has been involved in a collision, the detection of the collision may prompt the vehicle chatbot 120 to ask questions to occupants of the vehicle 106. For instance, the vehicle chatbot 120 may ask occupants whether they are hurt and/or are in need of medical attention due to the collision, ask the occupants whether they are trapped in the vehicle 106 or may safely get out of the vehicle 106, and/or ask other questions that may help determine the state of the occupants following the collision. In some examples, if the occupants do not or cannot respond to such questions from the vehicle chatbot 120, the collision responder 128 may determine that the occupants are unconscious and/or may be in need of medical attention or other emergency services.

In some examples, the collision responder 128 and/or the vehicle chatbot 120 may determine that, after a collision, occupants of the vehicle 106 cannot speak or are otherwise unable to contact emergency services or other external entities 126. In such situations, the vehicle chatbot 120 may initiate a conversation with emergency services or other external entities 126 on behalf of the occupants. For example, because the vehicle chatbot 120 may be configured to engage in natural language conversations via input audio and output audio as described above, the vehicle chatbot 120 may initiate a 911 call or other emergency call to a PSAP in order to report the collision. The vehicle chatbot 120 may also initiate a text message session and/or a text chat session with a PSAP, to engage in a text-based conversation with the PSAP.

The vehicle chatbot 120 may thus engage in a natural-language conversation with a PSAP operator to provide information to the PSAP operator about the collision, proactively and/or in response to questions from the PSAP operator. The vehicle chatbot 120 may, for example, provide the PSAP operator with information about a location of the collision, identifiers of the vehicle 106 and/or one or more occupants of the vehicle 106, and/or information derived from sensor data captured by sensors 110 of the vehicle 106 before, during, and/or after the collision. For instance, the vehicle chatbot 120 may provide GPS coordinates of the vehicle, information about a number of occupants based upon seatbelt sensors and/or seat pressure sensors, and/or any other information to the PSAP operator.

For instance, if the collision responder 128 determined that the occupants are unconscious and/or may be in need of medical attention or other emergency services, the vehicle chatbot 120 may convey that information to a PSAP operator. The vehicle chatbot 120 may also receive and interpret questions from the PSAP operator, and provide corresponding information to the PSAP operator in response. If occupants of the vehicle 106 are conscious and may interact with the vehicle chatbot 120, but may not be able to interact directly with the PSAP operator, the vehicle chatbot 120 may also engage in parallel conversations with the occupants and the PSAP operator, for instance to relay information between the occupants and the PSAP operator. If an occupant is conscious but is unable to speak clearly or loudly enough to communicate with the vehicle chatbot 120 and/or the PSAP operator, the vehicle chatbot 120 may provide sensor data, or statements summarizing observations derived based upon sensor data, to the PSAP operator.

The vehicle chatbot 120, the collision responder 128, and/or other elements of the smart vehicle assistant 102 may, in some situations, also transmit sensor data captured by sensors 110 of the vehicle 106 before, during, and/or after the collision to one or more external entities 126 in response to a detected collision. For example, the smart vehicle assistant 102 may transmit such sensor data to an insurance company, such that the insurance company may use the sensor data to process an insurance claim associated with the collision. As another example, the smart vehicle assistant 102 may transmit such sensor data to a police department or other response entity, such that the sensor data may be used to investigate the collision.

In some examples, if the collision responder 128 and/or the vehicle chatbot 120 determines that occupants are likely in need of medical attention and/or are physically unable to drive the vehicle 106 following a collision, the collision responder 128 may cause computing elements of the vehicle 106 to perform a self-diagnostic to determine whether sensors 110 and other elements associated with autonomous driving are undamaged and operable. If such a self-diagnostic indicates that that the vehicle 106 may perform autonomous driving operations without input from the occupants, the collision responder 128 may cause the vehicle 106 to autonomously drive to a hospital or medical provider, or to a location where the vehicle may rendezvous with an ambulance or other emergency services vehicle.

The collision responder 128 may cause the vehicle 106 to autonomously drive to a location to obtain assistance for occupants instead of, or in addition to, the vehicle chatbot 120 engaging in a conversation with a PSAP or other external entity. In some examples, the collision responder 128 may cause the vehicle 106 to autonomously drive to a location following a collision based upon instructions to do so that a PSAP operator or other external entity have provided to the vehicle chatbot 120. For example, the vehicle chatbot 120 may initiate a 911 call as discussed above, in response to a detected collision and a determination that occupants may be unconscious. The 911 operator may, during the call with the vehicle chatbot 120, provide instructions indicating that the vehicle 106 should autonomously drive to a particular hospital or rendezvous location to meet an ambulance, and the collision responder 128 may accordingly cause the vehicle 106 to autonomously drive to the location indicated by the 911 operator.

In other examples, the collision responder 128 may cause the vehicle 106 to autonomously drive away from the scene of a collision if collision response data 138, or other criteria, indicates that conditions are met such that the vehicle 106 is clear to depart the scene of the collision. As an example, the collision response data 138 may indicate that the vehicle 106 may depart the scene of the collision if the collision was a single-vehicle collision that did not involve other vehicles or people. As another example, the collision response data 138 may indicate that the vehicle 106 may depart the scene of the collision if the smart vehicle assistant 102 transmits sensor data captured by sensors 110 of the vehicle 106 before, during, and/or after the collision to an insurance company, to a police department, to emergency services, and/or to any other external entities 126. Accordingly, records associated with the collision that may be used for investigatory purposes and/or insurance claim purposes may be provided to such external entities 126 by the smart vehicle assistant 102, before and/or after the collision responder 128 causes the vehicle 106 to autonomously leave the scene of the collision.

Overall, one or more elements associated with the smart vehicle assistant 102 may provide information to a user before and/or during a trip taken via the vehicle 106. For example, the user may interact with the vehicle chatbot 120 via a natural language conversation so that the user may ask questions about insurance coverage, range-extension tips, and/or other topics, and receive answers to such questions from the vehicle chatbot 120. The vehicle chatbot 120 may also steer the conversation to such topics, for instance by proactively asking questions to the user and/or providing range-extension tips or other information to the user during the conversation.

If the vehicle 106 is involved in a collision, the smart vehicle assistant 102 may take one or more actions to respond to the collision, for instance by using the vehicle chatbot 120 to determine if occupants are responsive, by communicating with one or more external entities 126 on behalf of the occupants, and/or by causing the vehicle 106 to autonomously drive to a hospital or other location where help for the occupants may be available. As discussed further, a responder who responds to a collision involving the vehicle 106 may use a similar smart responder assistant 104 to obtain information about the vehicle 106 and/or determine how to respond to the collision, for instance via a conversation with the responder chatbot 122.

### Exemplary Smart Responder Assistant Usage

The responder chatbot 122 of the smart responder assistant 104 may be configured as described above to engage in conversation with a user who is or will be responding to a collision or other incident associated with the vehicle 106. For example, if the vehicle is in a collision and a driver or occupant calls a PSAP, or the vehicle chatbot 120 communicates with a PSAP on behalf of one or more occupants of the vehicle as described above, the PSAP may learn information about the collision and dispatch fire department personnel, emergency medical services personnel, or other emergency services personnel to respond to the collision. The user of the smart responder assistant 104 may be a responder who has been dispatched to respond to the collision. The user may use the smart responder assistant 104, for instance to interact with the responder chatbot 122, via the responder device 112 as discussed above. As described herein, the responder chatbot 122 may be configured to engage in a natural language conversations with one or more users via text, audio, and/or other types of media.

When the responder arrives at the scene of the collision, the responder may discover that one or more occupants may be trapped in the vehicle 106. However, the responder may be unfamiliar with the make or model of the vehicle 106, and accordingly be unsure which actions to take to extract the occupants from the vehicle 106 in the safest and/or quickest manner. For example, if the vehicle 106 is an EV, hybrid, or other type of vehicle that is powered by the battery 108, high-voltage cables and other electrical components may extend throughout significant portions of the structure of the vehicle 106. Cutting through such electrical elements of the vehicle 106 while attempting to extract occupants may pose risks of starting a fire, causing electrocution of the responder and/or occupants, and/or other risks. Similarly, if the collision damaged the structure of the vehicle 106, and portions of the vehicle 106 are cut during efforts to extract occupants, the cuts in combination with structural damage incurred during the collision may pose risks of the structure of the vehicle 106 collapsing. Accordingly, the responder may use the smart responder assistant 104, for instance by interacting with the responder chatbot 122, to obtain recommendations regarding which portions of the vehicle 106 should be cut to extract occupants in the safest and/or quickest manner.

The responder may provide input to the smart responder assistant 104 that identifies the make, model, year, and/or other attributes of the vehicle 106. As an example, the responder may provide text and/or voice input to the responder chatbot 122 that identifies the type of vehicle, such as via a manufacturer name, model name and/or year, body style, and/or other attributes of the vehicle 106. As another example, the responder may use a camera of the responder device 112 to provide an image or video that depicts the vehicle 106. In some examples, the responder may also provide text input, voice input, image input, and/or other input that identifies a Vehicle Identification Number (VIN) of the vehicle 106, a license plate number of the vehicle 106, or other identifier of the vehicle. In some examples, the responder chatbot 122 may proactively ask questions to the responder during a conversation that prompts the responder to provide text input, voice input, image input, and/or other input that may be used to identify the make, model, year, and/or other attributes of the vehicle 106.

Elements of the smart responder assistant 104, such as the response recommendation engine 130 may be configured to identify the make, model, year, and/or other attributes of the vehicle 106. For example, the response recommendation engine 130 may identify attributes of the vehicle 106 based upon text and/or audio data provided by a user, and/or use image recognition techniques to identify the vehicle based upon a provided photograph or video that depicts the vehicle 106. For instance, the response recommendation engine 130 may compare a photograph or video depicting the vehicle 106 against a database of images and/or videos of known vehicles, and use such a comparison to identify which of the known vehicles matches, or is closest to matching, the vehicle 106.

Based upon identifying the vehicle 106, the response recommendation engine 130 and/or other elements of the smart responder assistant 104 may also identify, retrieve, or access information about the vehicle 106, such as structural schematics and/or other structural information, electrical schematics and/or other information about electrical systems of the vehicle 106, information about the battery 108 of the vehicle 106, and/or other information. For example, the smart responder assistant 104 may access vehicle data 140 via a network to retrieve structural and/or electrical information about the vehicle 106.

In some examples, the user may also provide text input, voice input, image input, and/or other input that is indicative of the current structural state of the vehicle 106. For example, the responder may use a camera of the responder device 112 to provide an image or video that depicts the vehicle 106 and is indicative of the structural condition of the vehicle 106 following the collision. As another example, the responder may provide, via text input or voice input, a description of the structural condition of the vehicle 106 following the collision. In some examples, the responder chatbot 122 may proactively ask questions to the responder during a conversation that prompts the responder to provide text input, voice input, image input, and/or other input that may be indicative of the structural condition of the vehicle 106 following the collision.

Based upon input provided to the smart responder assistant 104, the responder chatbot 122, the user interface 118, and/or other elements of the smart responder assistant 104 may provide output that instructs the responder to perform particular response actions to respond to the collision and extract any occupants of the vehicle 106, and/or that recommends such response actions to the responder. In some examples, the output may include step-by-step instructions that guide the responder through a rescue process that may involve multiple response actions. The output may be based at least in part on determinations made by the response recommendation engine 130 and/or the damage estimator 132.

For example, the damage estimator 132 may compare input indicating a current structural state of the vehicle 106 against an expected or normal structural state of the vehicle 106, for instance based upon structural schematics or other information about the vehicle 106 retrieved by the response recommendation engine 130, to identify structural areas of the vehicle 106 that are currently damaged. The damage estimator 132 may also, or alternately, use input indicating a current structural state of the vehicle 106 and/or information about damage of the vehicle 106 relative to an expected or normal structural state, to estimate or predict structural elements of the vehicle 106 that may be at risk of failing or collapsing. For example, a particular portion of the vehicle 106 may appear undamaged to an observer, but damage to nearby portions of the vehicle 106 may indicate that the particular portion of the vehicle 106 has an increased risk of collapsing. The damage estimator 132 may also, or alternately, estimate times it would take to cut through different portions of the vehicle 106 based upon the current state of the vehicle 106, and/or recommend areas that may be quickest to cut in order to extract occupants.

The damage estimator 132 may be a component of the responder chatbot 122, or may be a separate machine learning model, a separate rules-based model, or another separate system. For example, the damage estimator 132 may be a machine learning model that based upon convolutional neural networks, recurrent neural networks, other types of neural networks, nearest-neighbor algorithms, regression analysis, deep learning algorithms, GBMs, Random Forest algorithms, and/or other types of artificial intelligence or machine learning frameworks. The model training system 134 may train the damage estimator 132 based upon one or more types of data, such as the vehicle data 140 associated with one or more types of vehicles, additional data 146 that is associated with example vehicle damage and/or that indicates likelihoods of structural failures due to the example vehicle damage, and/or other types of data. Accordingly, based upon current information about the state of the vehicle 106, and/or differences between the current state of the vehicle 106 and the normal or expected state of the vehicle 106, the damage estimator 132 may predict likelihoods of structural failures of components of the vehicle 106 and/or how potential cuts to various structural components of the vehicle 106 in order to rescue occupants would change the likelihoods of structural failures of those or other components of the vehicle 106.

Accordingly, the damage estimator 132 may identify which components of the vehicle 106 are damaged and/or may be at risk of collapsing if those components, or other components, were cut by the responder. The damage estimator 132 may also identify components of the vehicle 106 that could be safely cut, and/or estimate amounts of time it would take to cut such components.

Similarly, the response recommendation engine 130 may use retrieved structural and/or electrical information about the vehicle 106 to identify locations on the structure of the vehicle 106 that may be at risk of causing fire, electrocution, and/or other issues if such locations were to be cut during a rescue attempt. For example, the response recommendation engine 130 may use electrical schematics associated with the vehicle 106 to determine that high-voltage cables run through a particular portion of the body of the vehicle 106, and thus determine that cuts to that particular portion may lead to an increased risk of fire and/or electrocution. Similarly, the response recommendation engine 130 may identify locations on the structure of the vehicle 106 that do not have such risks, or pose fewer risks. For example, based upon electrical schematics associated with the vehicle 106, the response recommendation engine 130 may identify portions of the body of the vehicle 106 that do not contain high-voltage cables and may thus be relatively safe to cut in order to extract occupants.

The response recommendation engine 130 may be a component of the responder chatbot 122, or may be a separate machine learning model, a separate rules-based model, or another separate system. For example, the response recommendation engine 130 may be a machine learning model that based upon convolutional neural networks, recurrent neural networks, other types of neural networks, nearest-neighbor algorithms, regression analysis, deep learning algorithms, GBMs, Random Forest algorithms, and/or other types of artificial intelligence or machine learning frameworks. The model training system 134 may train the response recommendation engine 130 based upon one or more types of data, such as the vehicle data 140 associated with one or more types of vehicles, responder data 144 indicating how responders have responded, or should respond, to vehicle collisions in order to extract trapped occupants, additional data 146 associated to collision responses, and/or other types of data. Accordingly, based upon information about the vehicle 106 retrieved by the response recommendation engine 130, damage information provided by the damage estimator 132, and/or other information, the response recommendation engine 130 may predict which portions of the vehicle 106 may be cut the safest and/or quickest in order to extract occupants of the vehicle 106, and/or may generate corresponding step-by-step instructions or other recommendations for how the responder should act to extract the occupants of the vehicle 106.

Overall, the response recommendation engine 130 and/or the damage estimator 132 may determine output which portions of the vehicle 106 may be safest and/or quickest to cut in order to extract occupants, and/or which portions of the vehicle may be the riskiest and/or slowest to cut in order to extract the occupants. Corresponding output may be provided to a user of the smart responder assistant 104, for instance via the user interface 118 and/or the responder chatbot 122.

As an example, the responder chatbot 122 may receive user input regarding the identify and/or condition of the vehicle 106, and provide output determined by the response recommendation engine 130 and/or the damage estimator 132, via natural language questions and/or statements during a conversation. Accordingly, the responder chatbot 122 may provide instructions and/or recommendations regarding response actions via natural language text and/or audio output.

In some examples, the smart responder assistant 104 may also, or alternately, provide information about recommended response actions via image data, video data, haptic feedback, and/or other types of media or output. As an example, if the responder device 112 is an AR headset, smartphone, or other device that includes one or more cameras, the user interface 118 of the smart responder assistant 104 may present visual output that is overlaid over image data captured by the cameras of the responder device 112.

For example, if responder is wearing an AR headset while rescuing occupants of the vehicle 106, the user interface 118 of the smart responder assistant 104 may overlay AR representations identifying locations of high-voltage cables or other electrical elements over images of actual physical components that house those electrical elements. Similarly, the user interface 118 may overlay AR representations of areas that the response recommendation engine 130 recommends be cut, and/or does not recommend be cut, during the rescue operation. Similar AR representations may also be displayed via a mobile phone or other AR device. In other examples, image-based indications of locations of electrical elements and/or areas that are recommended to be cut or not cut may be presented via the user interface 118 without being overlaid over current images depicting the vehicle 106. Text-based and/or audio-based descriptions of such elements and/or areas may also, or alternately be presented via the user interface 118 and/or via the responder chatbot 122.

Accordingly, as described herein, the responder chatbot 122 and/or other elements of the smart responder assistant 104 may assist a responder before and/or during a rescue operation to extract one or more occupants within the vehicle 106. Such assistance may be conveyed during a natural-language conversation between the responder and the responder chatbot 122, via AR overlays or other information presented via the user interface 118 of the smart responder assistant 104, and/or via other output. In some examples, the responder chatbot 122 and/or other elements of the smart responder assistant 104 may also present information via a conversation with a user in other contexts. For example, a user of the responder chatbot 122 may be in training, and ask the responder chatbot 122 how a particular rescue situation should be handled. The responder chatbot 122 and/or other elements of the smart responder assistant 104 may respond by presenting training information, training videos, and/or other information about such a situation to the user. In some examples, such information may be accessed or retrieved from the responder data 144 or other data sources 116.

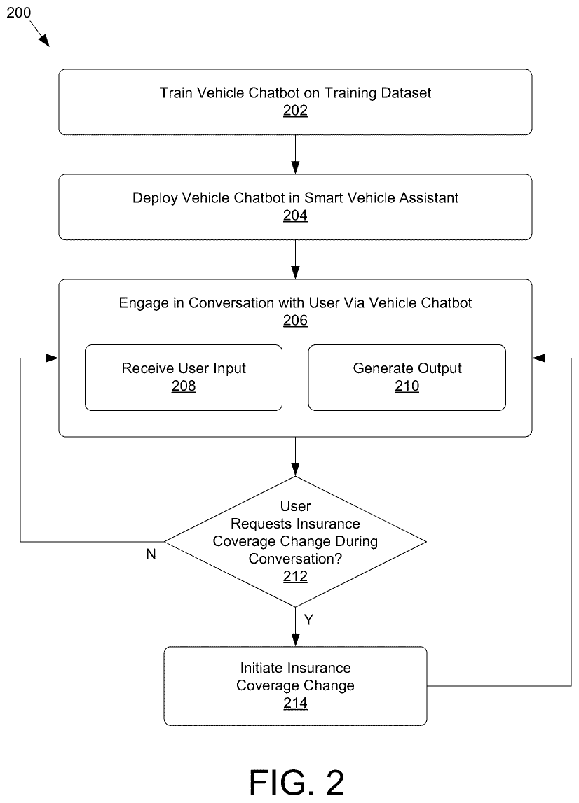

Flowcharts associated with operations associated with elements of the smart vehicle assistant 102, the smart responder assistant 104, the model training system 134, and/or other elements described herein are discussed further below with respect to FIGS. 2-4. An example system architecture that may be used to execute the smart vehicle assistant 102, the smart responder assistant 104, the model training system 134, and/or other elements described herein is discussed further below with respect to FIG. 5.

### Exemplary Vehicle Chatbot Method

FIG. 2 shows a flowchart illustrating an exemplary computer-implemented method 200 for training and using the vehicle chatbot 120 associated with the smart vehicle assistant 102. The method 200 shown in FIG. 2 may be performed by one or more computing systems, such as a computing system that executes the model training system 134 and/or a computing system that executes the smart vehicle assistant 102. An exemplary system architecture for such a computing system is described below with respect to FIG. 5.

At block 202, the model training system 134 may train the vehicle chatbot 120 on a training dataset. The training dataset may be based upon one or more types of information that may be provided and/or maintained by one or more data sources 116, such as insurance policy data 136, vehicle data 140, range data 142, additional data 146 including steering and driving data, and/or other types of information. The vehicle chatbot 120 may be based upon a GPT model, such as a large language model, that is trained based the training dataset using supervised learning, reinforcement learning, and/or other machine learning techniques. The model training system 134 may train the vehicle chatbot 120 to generate conversational statements and/or other output proactively, and/or in response to user questions or statements, based upon information that was in the training dataset at the time the vehicle chatbot 120 was trained and/or based upon other information that may be accessed by the vehicle chatbot 120 after training of the vehicle chatbot 120.

At block 204, the trained vehicle chatbot 120 may be deployed in the smart vehicle assistant 102. As discussed above, the smart vehicle assistant 102 may execute via a user device, via a dashboard system or other on-board computing system of the vehicle 106, and/or via one or more servers or a cloud computing environment that may be separate and/or remote from a user device and the vehicle 106. As an example, the vehicle chatbot 120 may be deployed in an instance of the smart vehicle assistant 102 that executes on a smartphone or other user device, or via an on-board computing system of the vehicle 106, and may be accessed by the user via the user device and/or a dashboard system of the vehicle 106.

At block 206, the vehicle chatbot 120 may engage in a conversation with a user. The user may, for example, be an occupant of the vehicle 106 who is inside the vehicle 106 before and/or during a trip. In some examples, the conversation may be initiated by the user, for instance before or during a trip. In other examples, the vehicle chatbot 120 or another element of the smart vehicle assistant 102 may initiate the conversation, for instance to ask questions about the user's planned destination and/or other details about a current or upcoming trip.

The vehicle chatbot 120 may engage in various operations during the conversation, such as receiving user input at block 208 and generating output at block 210. As an example, the vehicle chatbot 120 may receive a user query at block 208, and may generate corresponding output that responds to the user query at block 210. As another example, the vehicle chatbot 120 may generate and output a question for the user at block 210, and may receive a corresponding answer from the user at block 208.

During the conversation, the vehicle chatbot 120 may provide the user with generalized information, and/or specific or customized information. As an example, the vehicle chatbot 120 may provide output indicating whether an insurance policy associated with the vehicle 106 covers autonomous operations or other types of operations of the vehicle 106, based upon insurance policy data 136 associated with existing insurance policies. As another example, if the vehicle 106 is an EV, the vehicle chatbot 120 may provide output that suggests tips for extending the travel range and/or battery life of the EV, for instance based upon determinations or recommendations made by the range predictor 124.

As discussed above, the vehicle chatbot 120 may be based upon a GPT model or other generative AI system that may interpret natural language user input and/or generate natural language output during the conversation. Accordingly, the user may converse with the vehicle chatbot 120 naturally by asking free-form questions or making other natural language statements at block 208, and receiving corresponding natural language responses that are generated by the vehicle chatbot 120 at block 210 instead of, or in addition to, receiving prewritten responses or predetermined information.

As noted, in some embodiments, the voice bots or chatbots discussed herein, including the vehicle chatbot 120, may be configured to utilize AI and/or ML techniques. For instance, the vehicle chatbot 120 may be a large language model such as OpenAI GPT-4, Meta LLaMa, or Google PaML 2. The voice bots or chatbots may employ supervised or unsupervised ML techniques, which may be followed by, and/or used in conjunction with, reinforced or reinforcement learning techniques. The voice bots or chatbots may employ the techniques utilized for ChatGPT.

As discussed above, user input received at block 208 may be a user inquiry about whether one or more types of operations of the vehicle 106 are covered by an insurance policy, and the vehicle chatbot 120 may use insurance policy data 136 to generate a corresponding answer to that user inquiry. However, the vehicle chatbot 120 may also determine, at block 212, whether the user is requesting to a change to insurance coverage, for instance to add or adjust coverage in association with a type of vehicle operation. As an example, the user may want to add or change to usage-based insurance coverage, change existing insurance coverage to cover autonomous operations of the vehicle 106, or otherwise add and/or change insurance coverage.

If the user has not requested a change to insurance coverage during the conversation (Block 212—No), the conversation may continue at block 206. However, if the user has requested a change to insurance coverage during the conversation (Block 212—Yes), the vehicle chatbot 120 or other elements of the smart vehicle assistant 102 may at least initiate the change to the insurance coverage at block 214 before returning to the conversation.

For example, at block 214 the vehicle chatbot 120 or other elements of the smart vehicle assistant 102 may generate a quote for a new insurance policy or for changing an existing insurance policy, or may request that such a quote be generated by a separate system. The vehicle chatbot 120 may accordingly present the generated quote to the user during the conversation. In some examples, the user may provide user input during the conversation indicating that the user accepts the quote, and the vehicle chatbot 120 or other elements of the smart vehicle assistant 102 may accordingly transmit information that causes the quote to be accepted and/or corresponding changes to the user's insurance policy to be made in the insurance policy data 136.

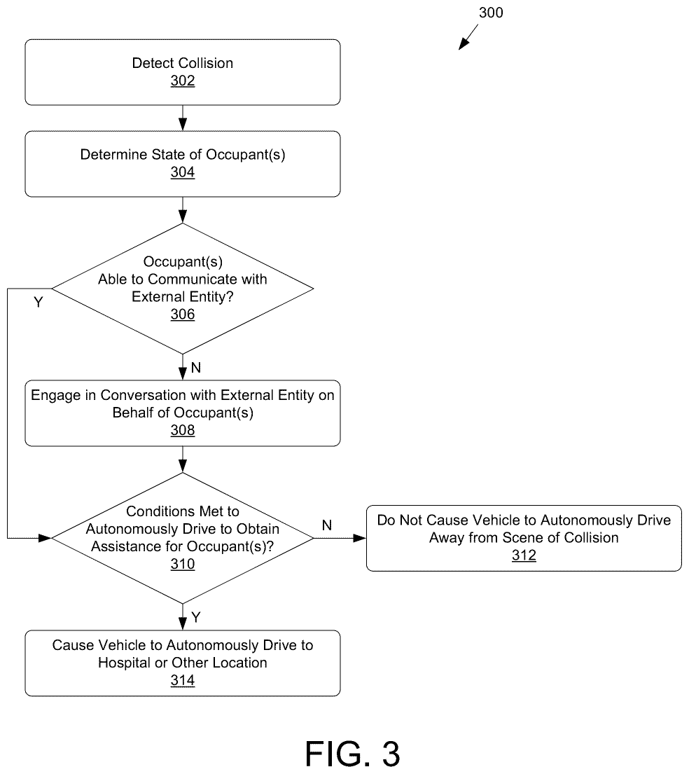

Overall, the vehicle chatbot 120 may be trained and deployed to provide information to a user before and/or during a trip in the vehicle, including insurance information, range extension tips, and/or other information. In some examples, such information, such as range-extension tips, may lead to safer driving that reduces the likelihood of accidents and corresponding insurance claims that are submitted to an insurance company. For instance, if range extension tips indicate that battery life of the vehicle 106 may be extended by driving at slower speeds, the risk of a collision may be lower if the user follows such tips by driving at slower speeds. Other aspects related to the vehicle chatbot 120 and/or other elements of the smart vehicle assistant 102 are discussed further below with respect to FIG. 3.

### Exemplary Vehicle Collision Response Method

FIG. 3 shows a flowchart illustrating an exemplary computer-implemented method 300 for using the smart vehicle assistant 102 to respond to a collision involving the vehicle 106. The method 300 shown in FIG. 3 may be performed by one or more computing systems, such as a computing system that executes the smart vehicle assistant 102. An example system architecture for such a computing system is described below with respect to FIG. 5.

At block 302, the smart vehicle assistant 102 may detect a collision involving the vehicle 106. The collision responder 128 of the smart vehicle assistant 102 may be configured to detect when the vehicle 106 is involved in a collision, for instance based upon accelerometer data or other motion data indicating a sudden decrease in travel speed, based upon camera data and/or microphone data that is indicative of a collision, and/or other types of data.

At block 304, the smart vehicle assistant 102 may determine a state of one or more occupants of the vehicle 106. For example, the collision responder 128 of the smart vehicle assistant 102 may be configured to detect whether occupants of the vehicle 106 are conscious and/or responsive, by using camera data, microphone data, motion sensor data, and/or other sensor data to determine whether occupants of the vehicle 106 are moving, or are stationary and may be unconscious, following the detected collision. The collision responder 128 may also use seatbelt sensors, seat pressure sensors, image analysis, and/or other systems and/or data processing techniques to determine how many occupants are in the vehicle 106. As another example, the vehicle chatbot 120 may initiate, or continue, a conversation in response to the detected collision, and use natural language text and/or audio questions to ask whether the occupants are hurt and/or in need of medical attention, ask whether the occupants are trapped in the vehicle 106 or may safely get out of the vehicle 106, and/or ask other questions that may help determine the state of the occupants following the collision.

At block 306, the smart vehicle assistant 102 may determine whether the occupants are able to communicate with a PSAP and/or other external entities 126. For example, if sensor data indicates that the occupants are conscious and/or the occupants respond to one or more questions posed by the vehicle chatbot 120, the smart vehicle assistant 102 may determine that the occupants are able to communicate with a PSAP and/or other external entities 126 (Block 306—Yes). However, if sensor data indicates that the occupants are unconscious, and/or may be conscious but are unable to speak, (Block 306—No) the smart vehicle assistant 102 may initiate a conversation with an external entity, such as a PSAP, on behalf of the occupants at block 308.

For example, at block 308, the smart vehicle assistant 102 may initiate a 911 call or text message session via cellular interfaces of the vehicle 106 and/or an associated user device, such that the vehicle chatbot 120 may engage in a conversation with a 911 operator. The vehicle chatbot 120 may engage in a natural language conversation with the 911 operator via audio and/or text, during which the vehicle chatbot 120 may provide information to the 911 operator, respond to questions from the 911 operator, and/or otherwise interact with the 911 operator on behalf of the occupants. For instance, the vehicle chatbot 120 may inform the 911 operator about the location of the vehicle 106, provide information derived from sensor data indicating whether other vehicles, people, or other objects were also involved in the collision, provide information on the state of the occupants determined at block 304, and/or provide any other information proactively and/or in response to questions from the 911 operator.

In some examples, the occupants may be conscious and responsive, but may be unable to themselves speak loudly or clearly enough to a PSAP operator or other external entity via a phone call or other type of communication session. In these examples, the vehicle chatbot 120 may engage in a conversation with the external entity at block 308, for instance to relay questions from the external entity to the occupants, and/or relay statements or questions from the occupants to the external entity.

In some examples, the smart vehicle assistant 102 may also, or alternately, transmit sensor data captured by sensors 110 of the vehicle 106 before, during, and/or after the collision to one or more external entities 126. For example, the smart vehicle assistant 102 may transmit sensor data associated with the collision to a PSAP instead of, or in addition to, engaging in a conversation with the PSAP via the vehicle chatbot 120. As another example, the smart vehicle assistant 102 may transmit sensor data associated with the collision to an insurance company in response to the detection of the collision, either because occupants are determined to be unresponsive and/or regardless of whether the occupants are unresponsive.

At block 310, if the occupants were able to themselves communicate with the external entity, after the vehicle chatbot 120 has engaged in a conversation with the external entity, and/or if no communications between the occupants or the vehicle chatbot 120 have taken place, the smart vehicle assistant 102 determine whether conditions have been met for the vehicle 106 to autonomously drive to obtain medical assistance or other types of assistance for the occupants. For example, the smart vehicle assistant 102 may be configured with conditions indicating that the vehicle 106 may autonomously drive away from the scene of the collision if the vehicle 106 has autonomous driving features and a self-diagnosis of the vehicle 106 indicates that the autonomous driving features are still operable following the collision.

As another example, the conditions may indicate that the vehicle 106 may autonomously drive away from the scene of the collision if sensor data indicates that the collision did not involve any other vehicles or people. As another example, the conditions may indicate that the vehicle 106 may autonomously drive away from the scene of the collision if sensor data captured before, during, and/or after the collision is transmitted by the smart vehicle assistant 102 to one or more external entities 126. As yet another example, the conditions may indicate that the vehicle 106 may autonomously drive away from the scene of the collision if the vehicle chatbot 120 engages in a conversation with a PSAP and a PSAP operator provides instructions during the conversation requesting that the vehicle 106 autonomous travel to a hospital, to a rendezvous location to meet an ambulance, or to another designated location.

If the conditions are not met for the vehicle 106 to autonomously drive following the collision (Block 310—No), the smart vehicle assistant 102 may determine to not cause the vehicle to autonomously drive away from the scene of the collision at block 312. However, if the conditions are met for the vehicle 106 to autonomously drive following the collision (Block 310—Yes), the smart vehicle assistant 102 may cause the vehicle to autonomous drive to a hospital or other location at block 314. In some examples, the location may be the nearest hospital or medical office based upon GPS coordinates of the location of the vehicle 106 and/or a database of hospitals or medical offices. In other examples, the location may be designated by a PSAP operator or other external entity, as discussed above. Accordingly, at block 314, the occupants may be transported by the vehicle 106 autonomously to a location where medical services may be provided to the occupants following the collision.

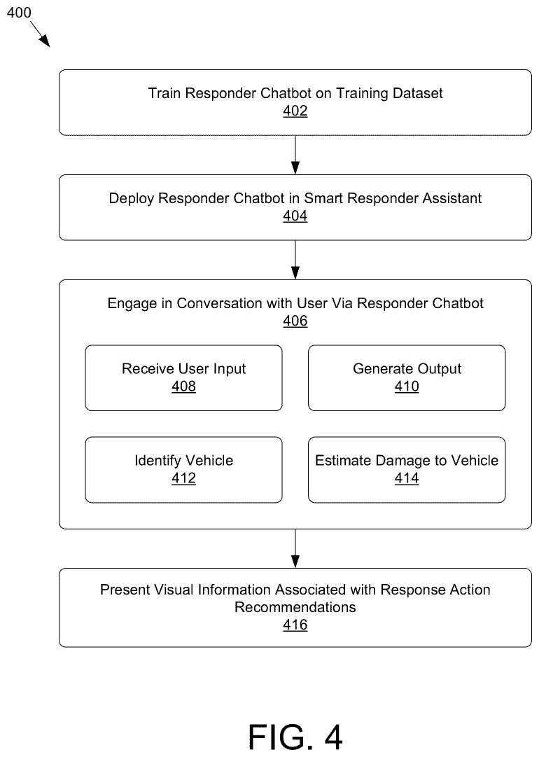

In some examples, if the vehicle is not caused to autonomously drive away from the scene of the collision and/or is unable to autonomously drive, a responder may be dispatched to respond to the scene of the collision by a PSAP operator or other external entity, such that the responder may provide medical services to the occupants, extract occupants who may be trapped in the vehicle 106, and/or otherwise assist the occupants. The responder may use the smart responder assistant 104 via the responder device 112, as described further below with respect to FIG. 4.

Exemplary Method Associated with Responder Chatbot

FIG. 4 shows a flowchart illustrating an exemplary computer-implemented method 400 for training and using the responder chatbot 122 associated with the smart responder assistant 104. The method 400 shown in FIG. 4 may be performed by one or more computing systems, such as a computing system that executes the model training system 134 and/or a computing system that executes the smart vehicle assistant 102, such as the responder device 112. An example system architecture for such a computing system is described below with respect to FIG. 5.

At block 402, the model training system 134 may train the responder chatbot 122 on a training dataset. The training dataset may be based upon one or more types of information that may be provided and/or maintained by one or more data sources 116, such as vehicle data 140, responder data 144, additional data 146, and/or other types of information. The responder chatbot 122 may be based upon a GPT model, such as a large language model, that is trained based the training dataset using supervised learning, reinforcement learning, and/or other machine learning techniques. The model training system 134 may train the responder chatbot 122 to generate conversational statements and/or other output proactively, and/or in response to user questions or statements, based upon information that was in the training dataset at the time the responder chatbot 122 was trained and/or based upon other information that may be accessed by the responder chatbot 122 after training of the responder chatbot 122.

At block 404, the trained responder chatbot 122 may be deployed in the smart responder assistant 104. As discussed above, the smart responder assistant 104 may execute at least in part via the responder device 112, such as a user device or a dashboard system or other on-board computing system of a response vehicle. For instance, the responder device 112 may be a smartphone, laptop computer, or other mobile computing device transported and/or used by the responder, AR goggles or another wearable device worn by the responder, or other type of computing device. In some examples, the smart responder assistant 104 may execute in part via one or more servers or a cloud computing environment that may be separate and/or remote from the responder device 112.

At block 406, the responder chatbot 122 may engage in a conversation with a responder when the responder is dispatched to respond to a collision involving the vehicle 106. The responder may be unsure of the type or identity of the vehicle 106, and/or be unsure how best to take action to extract occupants from the vehicle 106, and thus initiate the conversation with the responder chatbot 122 to obtain information about the vehicle 106 and/or recommendations regarding response actions from the responder chatbot 122 or other elements of the smart responder assistant 104.

The responder chatbot 122 may engage in various operations during the conversation with the responder, such as receiving user input at block 408, generating output at block 410, identifying the vehicle 106 at block 412, and/or estimating damage to the vehicle 106 at block 414. As an example, the responder chatbot 122 may receive a user query at block 408, and may generate corresponding output that responds to the user query at block 410. As another example, the responder chatbot 122 may generate and output a question for the user at block 410, and may receive a corresponding answer from the user at block 408.

During the conversation, the responder chatbot 122 may provide the responder with general information, such as general tips and/or instructions on how to respond to a collision or extract occupants from the vehicle 106. However, the responder chatbot 122 may also, or alternately, provide the responder with more specific and/or customized information associated with the collision and the state of the vehicle 106. As an example, based upon an identity of the vehicle 106, the response recommendation engine 130 may retrieve electrical and/or structural schematics for the vehicle 106, such that information from such schematics, or derived from such schematics, may be presented to the responder during the conversation. As another example, based upon images and/or a description of the current state of the vehicle 106, the damage estimator 132 may estimate or predict damage to the vehicle 106 such that corresponding output may be presented to the responder during the conversation.

As discussed above, the responder chatbot 122 may be based upon a GPT model or other generative AI system that may interpret natural language user input and/or generate natural language output during the conversation. Accordingly, the responder may converse with the responder chatbot 122 naturally by asking free-form questions or making other natural language statements at block 408, and receiving corresponding natural language responses that are generated by the responder chatbot 122 at block 410 instead of, or in addition to, receiving prewritten responses or predetermined information. In some examples, the responder chatbot 122 may also cause the smart responder assistant 104 to present how-to videos or other types of media to the responder proactively and/or in response to user input instead of, or in addition to, generating natural language output.

As noted, in some embodiments, the voice bots or chatbots discussed herein, including the responder chatbot 122, may be configured to utilize AI and/or ML techniques. For instance, the vehicle chatbot 120 may be a large language model such as OpenAI GPT-4, Meta LLaMa, or Google PaML 2. The voice bots or chatbots may employ supervised or unsupervised ML techniques, which may be followed by, and/or used in conjunction with, reinforced or reinforcement learning techniques. The voice bots or chatbots may employ the techniques utilized for ChatGPT.

At block 412, the responder chatbot 122 or other elements of the smart responder assistant 104 may identify the vehicle 106, such that the responder chatbot 122 and/or other elements of the smart responder assistant 104 may generate and provide output, such as response action recommendations, that is specific to the make, model, and/or type of the vehicle 106. In some examples, the responder may provide a text or audio description, a photograph, or other information to the responder chatbot 122 during the conversation, such that the responder chatbot 122 or other elements of the smart responder assistant 104 may identify the vehicle 106 based upon the user-provided input. Other elements of the smart responder assistant 104 may determine information based upon the identification of the vehicle 106. For example, as discussed above, the response recommendation engine 130 may use the identity of the vehicle to retrieve electrical and/or structural schematics for the vehicle 106, such that information from such schematics, or derived from such schematics, may be presented to the responder during the conversation. Similarly, based upon an identification of the vehicle 106, the damage estimator 132 may estimate or predict damage to the vehicle relative to an expected or normal state of the vehicle 106.

At block 414, the responder chatbot 122 or other elements of the smart responder assistant 104 may estimate damage to the vehicle 106 based upon user input provided during the conversation and/or based upon other information. For example, the responder may provide a natural language description of damage to the vehicle 106, or provide a photograph or video depicting the current state of the vehicle 106. The damage estimator 132 may use such information to estimate or predict damage levels to one or more components of the vehicle 106, and/or estimate or predict how actions to cut into such components would impact the structure of the vehicle 106 based upon current damage to the vehicle 106.

Overall, the output generated and provided during the conversation at block 410 may instruct the responder to perform particular response actions to respond to the collision and extract any occupants of the vehicle 106, and/or may recommend such response actions to the responder. In some examples, the output may also include step-by-step instructions that guide the responder through a rescue process that may involve multiple response actions. The output may be based at least in part on determinations made by the response recommendation engine 130 and/or the damage estimator 132, for instance in response to identifying the vehicle 106 at block 412 and/or estimating damage to the vehicle 106 at block 414. The output presented during the conversation at block 410 may accordingly indicate which portions of the vehicle 106 may be safest and/or quickest to cut in order to extract occupants, and/or which portions of the vehicle may be the riskiest and/or slowest to cut in order to extract the occupants.

In some examples, at block 416 the responder chatbot 122 and/or other elements of the smart responder assistant 104 may provide visual information associated with response action recommendations, instead of or in addition to presenting corresponding output via text or audio data during the conversation at block 410. For example, the user interface 118 via of the smart responder assistant 104 may display images or video that depict identified locations of electrical cables or other elements within the structure of the vehicle 106 that the response recommendation engine 130 recommends avoiding during rescue operations, and/or that depict other areas that the response recommendation engine 130 recommends cutting and/or not cutting during such rescue operations.

For instance, if the responder device 112 is an AR headset worn by the responder during rescue operations, the responder may engage in an audio conversation with the responder chatbot 122 at block 406, such that the responder may provide information during the conversation that identifies the vehicle 106 and/or that asks which parts of the vehicle 106 may be safest and/or quickest to cut in order to extract trapped occupants. The responder chatbot 122 may provide corresponding recommendations or other output via audio data in association with the conversation as discussed above. However, the responder chatbot 122 or other elements of the smart responder assistant 104 may also cause visual AR representations of locations of high-voltage cables, other electrical elements, components that the response recommendation engine 130 recommends cutting and/or not cutting, and/or other elements to be overlaid over corresponding structural components of the vehicle 106 within images depicting the vehicle 106 seen by the responder via the AR headset. Accordingly, such visual information presented at block 416 instead of, or in addition to, an audio or text-based conversation may assist the responder in determining which portions of the vehicle 106 are safest and/or quickest to cut in order to extract occupants of the vehicle 106.

### Exemplary Computer System Architecture

FIG. 5 shows an exemplary system architecture 500 for a computing system 502 that may execute one or more elements associated with the smart vehicle assistant 102, the smart responder assistant 104, the model training system 134, and/or other elements described herein. In some examples, the computing system 502 may be a user device, such a smartphone, computer, AR headset, or other type of computing device. In other examples, the computing system 502 may be an on-board computing system of the vehicle 106 or a response vehicle, such as a computing system that executes a vehicle dashboard system and/or other vehicle systems. In still other examples, the computing system 502 may be a server or element of a cloud computing system that is separate and/or remote from a user device, the vehicle 106, and/or a response vehicle. The computing system 502 may include one or more computers, servers, or other types of computing devices. Individual computing devices of the computing system 502 may have the system architecture 500 shown in FIG. 5, or a similar system architecture.

In some examples, elements of the smart vehicle assistant 102, the smart responder assistant 104, the model training system 134, and/or other elements described herein may be distributed among, and/or be executed by, multiple computing systems or devices similar to the computing system 502 shown in FIG. 5. As an example, frontend elements of the smart vehicle assistant 102 may be executed by a user device and/or a dashboard system of the vehicle, while backend elements of the smart vehicle assistant 102 may be executed by one or more remote servers and/or elements of a cloud computing environment. Similarly, frontend elements of the smart responder assistant 104 may be executed by the responder device 112, while backend elements of the smart responder assistant 104 may be executed by one or more remote servers and/or elements of a cloud computing environment. As another example, the model training system 134 may be executed via one or more computing systems that are different from one or more computing systems that execute the smart vehicle assistant 102 and/or the smart responder assistant 104.

The computing system 502 may include memory 504. In various examples, the memory 504 may include system memory, which may be volatile (such as RAM), non-volatile (such as ROM, flash memory, etc.) or some combination of the two. The memory 504 may further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which may be used to store desired information and which may be accessed by the computing system 502. Any such non-transitory computer-readable media may be part of the computing system 502.

The memory 504 may store modules and data 506, including software or firmware elements, such as data and/or computer-readable instructions that are executable by one or more processors 508. As an example, the memory 504 may store computer-executable instructions and data associated with one or more elements of the smart vehicle assistant 102, such as the user interface 118 of the smart vehicle assistant 102, the vehicle chatbot 120, the range predictor 124, and/or the collision responder 128. As another example, the memory 504 may store computer-executable instructions and data associated with one or more elements of the smart responder assistant 104, such as the user interface 118 of the smart responder assistant 104, the responder chatbot 122, the response recommendation engine 130, and/or the damage estimator 132. As yet another example, the memory 504 may store computer-executable instructions and data associated with the model training system 134.

The modules and data 506 stored in the memory 504 may also include any other modules and/or data that may be utilized by the computing system 502 to perform or enable performing any action taken by the computing system 502. Such modules and data 506 may include a platform, operating system, and applications, and data utilized by the platform, operating system, and applications.

The computing system 502 may also have processor(s) 508, communication interfaces 510, a display 512, output devices 514, input devices 516, and/or a drive unit 518 including a machine readable medium 520.

In various examples, the processor(s) 508 may be a central processing unit (CPU), a graphics processing unit (GPU), both a CPU and a GPU, or any other type of processing unit. Each of the one or more processor(s) 508 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 508 may also be responsible for executing computer applications stored in the memory 504, which may be associated with types of volatile (RAM) and/or nonvolatile (ROM) memory.

The communication interfaces 510 may include transceivers, modems, network interfaces, antennas, and/or other components that may transmit and/or receive data over networks or other connections. The communication interfaces 510 may be used to exchange data between elements described herein. For instance, in some examples, the communication interfaces 510 may receive user input and/or sensor data, and/or may transmit or receive data via cellular networks, wireless networks, and/or other networks. For example, the communication interfaces 510 may be used to access one or more types of information from one or more data sources 116.

The display 512 may be a liquid crystal display, or any other type of display used in computing devices. In some examples, the display 512 may be a screen or other display of a dashboard system of the vehicle 106 or a response vehicle, or of the responder device 112 or another user device. The output devices 514 may include any sort of output devices known in the art, such as the display 512, speakers, a vibrating mechanism, and/or a tactile feedback mechanism. Output devices 514 may also include ports for one or more peripheral devices, such as peripheral speakers and/or a peripheral display. In some examples, output of one or more of the chatbots and/or user interfaces described herein may be presented via the display 512 and/or the output devices 514.

The input devices 516 may include any sort of input devices known in the art. For example, input devices 516 may include a microphone, a keyboard/keypad, and/or a touch-sensitive display, such as a touch-sensitive display screen. A keyboard/keypad may be a push button numeric dialing pad, a multi-key keyboard, or one or more other types of keys or buttons, and may also include a joystick-like controller, designated navigation buttons, or any other type of input mechanism. In some examples, the user input may be provided via the input devices 516. In some examples, the input devices 516 may also, or alternately, include the sensors 110, such that sensor data may be provided via the input devices 516.

The machine readable medium 520 may store one or more sets of instructions, such as software or firmware, that embodies any one or more of the methodologies or functions described herein. The instructions may also reside, completely or at least partially, within the memory 504, processor(s) 508, and/or communication interface(s) 510 during execution thereof by the computing system 502. The memory 504 and the processor(s) 508 also may constitute machine readable media 520.

Although the subject matter has been described in language specific to structural features and/or methodological acts, it is to be understood that the subject matter is not necessarily limited to the specific features or acts described above. Rather, the specific features and acts described above are disclosed as example embodiments.

### Exemplary Embodiments

In one aspect, a computer-implemented method may interact with a user via a smart vehicle assistant and/or an associated chatbot. The method may include (1) providing, by a vehicle computing system of a vehicle that includes one or more processors, a smart vehicle assistant including a chatbot trained, based upon a training dataset, to engage in a conversation with a user in association with the vehicle; (2) receiving, by the vehicle computing system, and via the chatbot during the conversation, user input including natural language input; (3) generating, by the vehicle computing system, and via the chatbot, natural language output based at least in part on the user input; and/or (4) presenting, by the vehicle computing system, and via the chatbot, the natural language output during the conversation. The method may include additional, less, or alternate functionality, including that discussed elsewhere herein.

For instance, the chatbot may be a generative pre-trained transformer (GPT) model trained on the training dataset. The training dataset may include: (i) insurance policy information associated with a set of insurance policies provided by an insurance company; (ii) collision response data indicating actions to perform in response to vehicle collisions; (iii) vehicle data indicating attributes of vehicles; and/or (iv) range data indicating at least one of travel ranges or battery life ranges associated with electric vehicles.

In some aspects, the vehicle may be an autonomous vehicle configured to perform autonomous driving operations. The natural language output may express insurance coverage information indicating whether an insurance policy covers the autonomous driving operations of the vehicle. The method may include (i) determining, by the vehicle computing system, that the user input requests a change to the insurance policy to cover the autonomous driving operations; and (ii) initiating, by the vehicle computing system, the change to the insurance policy based upon the user input.

In some aspects, the vehicle may be an electric vehicle powered by a battery. The natural language output may express recommended driving actions predicted to extend at least one of a travel range of the electric vehicle or a battery life of the battery.

In some aspects, the user may be an occupant of the vehicle. In other aspects, the use may be a Public Safety Answering Point (PSAP) operator, and the method may include initiating, by the vehicle computing system, the conversation with the PSAP operator via the chatbot through a cellular connection based upon a determination that the vehicle has been in a collision and one or more occupants of the vehicle are unable to communicate with the PSAP operator.

In some aspects, the vehicle may be an autonomous vehicle configured to perform autonomous driving operations, and the method may include (i) determining, by the vehicle computing system, that the vehicle has been in a collision; (ii) determining, by the vehicle computing system, that the vehicle is capable of performing the autonomous driving operations following the collision; and (iii) causing, by the vehicle computing system, the vehicle to autonomously drive to a hospital or other location where occupants of the vehicle may receive medical assistance.

In another aspect, a computer system for interacting with a user via a smart vehicle assistant and/or associated chatbot or voice bot may be provided. The computer system may be a vehicle computing system of a vehicle that may include one or more processors, and memory storing computer-executable instructions that, when executed by the one or more processors, cause the one or more processors to: (1) provide a smart vehicle assistant including a chatbot trained, based upon a training dataset, to engage in a conversation with a user in association with the vehicle, wherein the user is: an occupant of the vehicle, or associated with an external entity separate from the vehicle; (2) receive, via the chatbot during the conversation, user input including natural language input; (3) generate, via the chatbot, natural language output based at least in part on the user input; and/or (4) present, via the chatbot, the natural language output during the conversation. The computer system may provide additional, less, or alternate functionality, including that discussed elsewhere herein.

In another aspect, non-transitory computer-readable media storing computer-executable instructions for interacting with a user via a smart vehicle assistant and/or associated chatbot or voice bot may be provided. The computer-executable instructions, when executed by one or more processors of a computing system of a vehicle, may cause the one or more processors to: (1) provide a smart vehicle assistant including a chatbot trained, based upon a training dataset, to engage in a conversation with a user in association with the vehicle, wherein the user is: an occupant of the vehicle, or associated with an external entity separate from the vehicle; (2) receive, via the chatbot during the conversation, user input including natural language input; (3) generate, via the chatbot, natural language output based at least in part on the user input; and/or (4) present, via the chatbot, the natural language output during the conversation. The computer-executable instructions may provide additional, less, or alternate functionality, including that discussed elsewhere herein.

### ADDITIONAL CONSIDERATIONS

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112 (f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for assisting a user associated with a vehicle, comprising:
providing, by a vehicle computing system of the vehicle that comprises one or more processors, a smart vehicle assistant comprising a chatbot trained, based upon a training dataset, to engage in a conversation with the user in association with the vehicle;
receiving, by the vehicle computing system, and via the chatbot during the conversation, user input comprising natural language input;
generating, by the vehicle computing system, and via the chatbot, natural language output based at least in part on the user input; and
presenting, by the vehicle computing system, and via the chatbot, the natural language output during the conversation.

2. The computer-implemented method of claim 1, wherein the chatbot is a generative pre-trained transformer (GPT) model trained on the training dataset.

3. The computer-implemented method of claim 1, wherein the training dataset comprises at least one of:
insurance policy information associated with a set of insurance policies provided by an insurance company,
collision response data indicating actions to perform in response to vehicle collisions,
vehicle data indicating attributes of vehicles, or
range data indicating at least one of travel ranges or battery life ranges associated with electric vehicles.

4. The computer-implemented method of claim 1, wherein:
the vehicle is an autonomous vehicle configured to perform autonomous driving operations, and
the natural language output expresses insurance coverage information indicating whether an insurance policy covers the autonomous driving operations of the vehicle.

5. The computer-implemented method of claim 4, further comprising:
determining, by the vehicle computing system, that the user input requests a change to the insurance policy to cover the autonomous driving operations; and
initiating, by the vehicle computing system, the change to the insurance policy based upon the user input.

6. The computer-implemented method of claim 1, wherein:
the vehicle is an electric vehicle powered by a battery, and
the natural language output expresses recommended driving actions predicted to extend at least one of a travel range of the electric vehicle or a battery life of the battery.

7. The computer-implemented method of claim 1, wherein the user is an occupant of the vehicle.

8. The computer-implemented method of claim 1, wherein the user is a Public Safety Answering Point (PSAP) operator, and the method further comprises:
initiating, by the vehicle computing system, the conversation with the PSAP operator via the chatbot through a cellular connection based upon a determination that the vehicle has been in a collision and one or more occupants of the vehicle are unable to communicate with the PSAP operator.

9. The computer-implemented method of claim 1, wherein the vehicle is an autonomous vehicle configured to perform autonomous driving operations, and the method further comprises:
determining, by the vehicle computing system, that the vehicle has been in a collision;
determining, by the vehicle computing system, that the vehicle is capable of performing the autonomous driving operations following the collision; and
causing, by the vehicle computing system, the vehicle to autonomously drive to a hospital or other location where occupants of the vehicle may receive medical assistance.

10. A vehicle computing system of a vehicle configured to assist a user, comprising:
one or more processors, and
memory storing computer-executable instructions that, when executed by the one or more processors, cause the one or more processors to:
provide a smart vehicle assistant comprising a chatbot trained, based upon a training dataset, to engage in a conversation with the user in association with the vehicle, wherein the user is:
an occupant of the vehicle, or
associated with an external entity separate from the vehicle;
receive, via the chatbot during the conversation, user input comprising natural language input;
generate, via the chatbot, natural language output based at least in part on the user input; and
present, via the chatbot, the natural language output during the conversation.

11. The vehicle computing system of claim 10, wherein:
the vehicle is an autonomous vehicle configured to perform autonomous driving operations, and
the natural language output expresses insurance coverage information indicating at least one of:
an indication of whether an insurance policy covers the autonomous driving operations of the vehicle, or
one or more options to adjust the insurance policy, or to add a new insurance policy, to cover the autonomous driving operations of the vehicle.

12. The vehicle computing system of claim 10, wherein:
the vehicle is an electric vehicle powered by a battery, and
the natural language output expresses recommended driving actions predicted to extend at least one of a travel range of the electric vehicle or a battery life of the battery.

13. The vehicle computing system of claim 10, wherein:
the user is the occupant of the vehicle,
the chatbot receives the user input as at least one of text input or audio input via one or more input devices of the vehicle, and
the chatbot presents the natural language output as at least one of text output or audio output via at least one of a dashboard screen, speakers, or other output devices of the vehicle.

14. The vehicle computing system of claim 10, wherein the user is a public safety answering point (PSAP) operator, and the computer-executable instructions further cause the one or more processors to:
initiate the conversation with the PSAP operator via the chatbot through a cellular connection based upon a determination that the vehicle has been in a collision and one or more occupants of the vehicle are unable to communicate with the PSAP operator.

15. The vehicle computing system of claim 10, wherein the vehicle is an autonomous vehicle configured to perform autonomous driving operations, and the computer-executable instructions further cause the one or more processors to:
determine that the vehicle has been in a collision;
determine that the vehicle is capable of performing the autonomous driving operations following the collision; and
cause the vehicle to autonomously drive to a hospital or other location where occupants of the vehicle may receive medical assistance.

16. One or more non-transitory computer-readable media storing computer-executable instructions, associated with a smart vehicle assistant configured to assist a user associated with a vehicle, that, when executed by one or more processors of a computing system of the vehicle, cause the one or more processors to:
provide the smart vehicle assistant comprising a chatbot trained, based upon a training dataset, to engage in a conversation with the user in association with the vehicle, wherein the user is:
an occupant of the vehicle, or
associated with an external entity separate from the vehicle;
receive, via the chatbot during the conversation, user input comprising natural language input;
generate, via the chatbot, natural language output based at least in part on the user input; and
present, via the chatbot, the natural language output during the conversation.

17. The one or more non-transitory computer-readable media of claim 16, wherein:
the vehicle is an autonomous vehicle configured to perform autonomous driving operations, and
the natural language output expresses insurance coverage information indicating at least one of:
an indication of whether an insurance policy covers the autonomous driving operations of the vehicle, or
one or more options to adjust the insurance policy, or to add a new insurance policy, to cover the autonomous driving operations of the vehicle.

18. The one or more non-transitory computer-readable media of claim 16, wherein:
the vehicle is an electric vehicle powered by a battery, and
the natural language output expresses recommended driving actions predicted to extend at least one of a travel range of the electric vehicle or a battery life of the battery.

19. The one or more non-transitory computer-readable media of claim 16, wherein the user is a public safety answering point (PSAP) operator, and the computer-executable instructions further cause the one or more processors to:
initiate the conversation with the PSAP operator via the chatbot through a cellular connection based upon a determination that the vehicle has been in a collision and one or more occupants of the vehicle are unable to communicate with the PSAP operator.

20. The one or more non-transitory computer-readable media of claim 16, wherein the vehicle is an autonomous vehicle configured to perform autonomous driving operations, and the computer-executable instructions further cause the one or more processors to:
determine that the vehicle has been in a collision;
determine that the vehicle is capable of performing the autonomous driving operations following the collision; and
cause the vehicle to autonomously drive to a hospital or other location where occupants of the vehicle may receive medical assistance.
